(19) United States
(12) Patent Application Publication
(10) Pub. No.: US 2022/0238860 A1
(43) Pub. Date: Jul. 28, 2022

(54) NANOCOMPOSITE AND METHOD OF MAKING CATALYST FOR HIGH LOADING AND UTILIZATION OF SULFUR AT ELEVATED TEMPERATURES

(71) Applicants: SAUDI ARABIAN OIL COMPANY, Dhahran (SA); ALFAISAL UNIVERSITY, Riyadh (SA)

(72) Inventors: Muhammad Arsalan, Khobar (SA); Edreese Alsharaeh, Riyadh (SA); Yasmin Mussa, Riyadh (SA)

(73) Assignees: SAUDI ARABIAN OIL COMPANY, Dhahran (SA); ALFAISAL UNIVERSITY, Riyadh (SA)

(21) Appl. No.: 17/155,844

(22) Filed: Jan. 22, 2021

(51) Int. Cl. H01M 4/36; H01M 10/052; H01M 4/38; H01M 4/48; H01M 4/583; H01M 4/04; H01M 4/1393

(52) U.S. Cl. CPC H01M 4/364; H01M 10/052; H01M 4/38; H01M 2004/021; H01M 4/583; H01M 4/0404; H01M 4/1393; H01M 4/483

(57) ABSTRACT

An electrode that includes a nanocomposite and sulfur is provided. The nanocomposite includes from 0.1 to 15 wt. % of a metal oxide, carbon, and h-BN. Also provided is a lithium-sulfur battery that has an anode, a cathode, a separator and an electrolyte. The cathode of the lithium-sulfur battery includes the nanocomposite and sulfur. A method of preparing an electrode is also provided. The method includes milling a metal precursor, carbon, and h-BN to make a precursor mixture and heating the precursor mixture to a predetermined temperature in the presence of oxygen to form the nanocomposite. The method then includes mixing the nanocomposite with sulfur to create an electrode mixture, and forming an electrode from the electrode mixture.

### BACKGROUND

Rechargeable batteries are used to power a broad range of consumer devices such as electric vehicles and portable electronic devices. Rechargeable batteries are, however, susceptible to failure and can be unsafe under “abuse conditions” such as when a rechargeable battery is overcharged, over-discharged, or operated at high temperature and high pressure. For example, when operated at high temperature, a rechargeable battery can undergo thermal runaway. During thermal runaway, high temperatures trigger a chain of exothermic reactions in a battery, causing the battery's temperature to increase rapidly. Thermal runaway can cause battery failure, damage to devices, and harm to users. During thermal runaway, rechargeable batteries such as lithium-ion and lithium-sulfur batteries can be prone to fire and explosion because the electrode materials (for example, anode and cathode materials) can be highly reactive and unstable. Even when thermal runaway does not occur, electrode materials used in rechargeable batteries can suffer from performance decay when operated at high temperatures.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to an electrode material that includes a nanocomposite and sulfur. The nanocomposite includes from 0.1 to 15 wt. % of a metal oxide, carbon, and h-BN.

In another aspect, embodiments disclosed herein relate to a lithium-sulfur battery that has an anode, a cathode, a separator and an electrolyte. The cathode of the lithium-sulfur battery includes a nanocomposite and sulfur. The nanocomposite includes from 0.1 to 15 wt. % of a metal oxide, carbon, and h-BN.

In yet another aspect, embodiments disclosed herein relate to a method of preparing an electrode. The method includes milling a metal precursor, carbon, and h-BN to make a precursor mixture and heating the precursor mixture to a predetermined temperature in the presence of oxygen to form a nanocomposite. The nanocomposite includes from 0.1 to 15 wt. % of a metal oxide. The method then includes mixing the nanocomposite with sulfur to create an electrode mixture, and forming an electrode from the electrode mixture.

Other aspects and advantages of the claimed subject matter will be apparent from the following description and the appended claims.

### BRIEF DESCRIPTION OF DRAWINGS

FIG. 1 is a plot of X-ray diffraction data of nanocomposites with different Co₃O₄ amounts in accordance with one or more embodiments of the present disclosure.

FIG. 2 is a plot of X-ray diffraction data of nanocomposites with different compositions in accordance with one or more embodiments of the present disclosure.

FIG. 3 is a plot of X-ray diffraction data of nanocomposites with different compositions in accordance with one or more embodiments of the present disclosure.

FIG. 4 is a plot of X-ray diffraction data of nanocomposites processed at different calcination temperatures in accordance with one or more embodiments of the present disclosure.

FIG. 5 is a plot of X-ray diffraction data of nanocomposites processed at different calcination temperatures in accordance with one or more embodiments of the present disclosure.

FIG. 6 is a plot of X-ray diffraction data of nanocomposites with different compositions in accordance with one or more embodiments of the present disclosure.

FIG. 7 is a plot of X-ray diffraction data of nanocomposites with different compositions in accordance with one or more embodiments of the present disclosure.

FIG. 8 is a plot of X-ray diffraction data of nanocomposites with different compositions in accordance with one or more embodiments of the present disclosure.

FIG. 9 is a plot of thermogravimetric analysis data of nanocomposites with different compositions in accordance with one or more embodiments of the present disclosure.

FIG. 10 is a plot of thermogravimetric analysis data of nanocomposites with different compositions in accordance with one or more embodiments of the present disclosure.

FIG. 11 is a plot of galvanostatic charge-discharge data of nanocomposites with different compositions employed in Li—S electrochemical cells in accordance with one or more embodiments of the present disclosure.

FIG. 12 is a chart comparing the specific capacities and polarization values for nanocomposites with different Co₃O₄ amounts employed in Li—S electrochemical cells in accordance with one or more embodiments of the present disclosure.

FIG. 13A is a chart comparing the capacities (Q_{H}) for nanocomposites with different Co₃O₄ amounts employed in Li—S electrochemical cells in accordance with one or more embodiments of the present disclosure.

FIG. 13B is a chart comparing the capacities (Q_{L}) for nanocomposites with different Co₃O₄ amounts employed in Li—S electrochemical cells in accordance with one or more embodiments of the present disclosure.

FIG. 14 is a plot of electrochemical data at different current rates for nanocomposites with different compositions employed in Li—S electrochemical cells in accordance with one or more embodiments of the present disclosure.

FIG. 15 is a plot comparing the electrochemical data of FIG. 14.

FIG. 16 is a plot of galvanostatic charge-discharge data of nanocomposites with different compositions employed in Li—S electrochemical cells in accordance with one or more embodiments of the present disclosure.

FIG. 17 is a plot of electrochemical data at different current rates for nanocomposites with different compositions employed in Li—S electrochemical cells in accordance with one or more embodiments of the present disclosure.

FIG. 18 is a plot comparing the electrochemical data of FIG. 17.

FIG. 19A is a plot of galvanostatic charge-discharge data of nanocomposites with different compositions employed in Li—S electrochemical cells in accordance with one or more embodiments of the present disclosure.

FIG. 19B is a plot of galvanostatic charge data of nanocomposites with different compositions employed in Li—S electrochemical cells in accordance with one or more embodiments of the present disclosure.

FIG. 20A is a plot comparing the electrochemical data of FIG. 19A.

FIG. 20B is a plot comparing the electrochemical data of FIG. 19B.

FIG. 21 is a plot of the specific capacities and sulfur utilization values of nanocomposites with different compositions employed in Li—S electrochemical cells in accordance with one or more embodiments of the present disclosure.

FIG. 22 is a plot of galvanostatic charge-discharge data at room temperature of nanocomposites with different compositions employed in Li—S electrochemical cells in accordance with one or more embodiments of the present disclosure.

FIG. 23 is a plot of galvanostatic charge-discharge data at 50° C. of nanocomposites with different compositions employed in Li—S electrochemical cells in accordance with one or more embodiments of the present disclosure.

FIG. 24 is a plot of galvanostatic charge-discharge data at 100° C. of nanocomposites with different compositions employed in Li—S electrochemical cells in accordance with one or more embodiments of the present disclosure.

FIG. 25A is a chart comparing the capacities (Q_{H}) at different charge rates for nanocomposites employed in Li—S electrochemical cells in accordance with one or more embodiments of the present disclosure.

FIG. 25B is a chart comparing the capacities (Q_{L}) at different charge rates for nanocomposites employed in Li—S electrochemical cells in accordance with one or more embodiments of the present disclosure.

FIG. 26A is a plot of room temperature electrochemical data at different current rates for nanocomposites with different compositions employed in Li—S electrochemical cells in accordance with one or more embodiments of the present disclosure.

FIG. 26B is a plot of electrochemical data at 50° C. at different current rates for nanocomposites with different compositions employed in Li—S electrochemical cells in accordance with one or more embodiments of the present disclosure.

FIG. 26C is a plot of electrochemical data at 100° C. at different current rates for nanocomposites with different compositions employed in Li—S electrochemical cells in accordance with one or more embodiments of the present disclosure.

FIG. 27 is a plot comparing the electrochemical data of FIG. 26A, 26B, 26C.

FIG. 28 is a plot of X-ray diffraction data of nanocomposites with different compositions in accordance with one or more embodiments of the present disclosure.

FIG. 29 is a plot of thermogravimetric analysis data of nanocomposites with different compositions in accordance with one or more embodiments of the present disclosure.

FIG. 30 is a plot of X-ray diffraction data of nanocomposites with different compositions in accordance with one or more embodiments of the present disclosure.

FIG. 31 is a plot of thermogravimetric analysis data of nanocomposites with different compositions in accordance with one or more embodiments of the present disclosure.

FIG. 32 is a plot of galvanostatic charge-discharge data of nanocomposites with different compositions employed in Li—S electrochemical cells in accordance with one or more embodiments of the present disclosure.

FIG. 33 is a plot of electrochemical data at different current rates for nanocomposites with different compositions employed in Li—S electrochemical cells in accordance with one or more embodiments of the present disclosure.

FIG. 34 is a plot comparing the electrochemical data of FIG. 33.

FIG. 35 is a plot of galvanostatic charge-discharge data at different current rates of nanocomposites employed in Li—S electrochemical cells in accordance with one or more embodiments of the present disclosure.

FIG. 36 is a plot of X-ray diffraction data of nanocomposites prepared using different milling methods in accordance with one or more embodiments of the present disclosure.

FIG. 37 is a plot of thermogravimetric analysis data of nanocomposites prepared using different milling methods in accordance with one or more embodiments of the present disclosure.

FIG. 38 is a plot of X-ray diffraction data of nanocomposites prepared using different milling methods in accordance with one or more embodiments of the present disclosure.

FIG. 39 is a plot of thermogravimetric analysis data of nanocomposites prepared using different milling methods in accordance with one or more embodiments of the present disclosure.

FIG. 40 is a plot of galvanostatic charge-discharge data of nanocomposites prepared using different milling methods employed in Li—S electrochemical cells in accordance with one or more embodiments of the present disclosure.

FIG. 41 is a plot of electrochemical data at different current rates for nanocomposites prepared using different milling methods employed in Li—S electrochemical cells in accordance with one or more embodiments of the present disclosure.

FIG. 42 is a plot comparing the electrochemical data of FIG. 41.

FIG. 43 is a plot of galvanostatic charge-discharge data of nanocomposites employed in Li—S electrochemical cells in accordance with one or more embodiments of the present disclosure.

FIG. 44 is a plot of X-ray diffraction data of nanocomposites of different compositions in accordance with one or more embodiments of the present disclosure.

FIG. 45 is a plot of galvanostatic charge-discharge data of nanocomposites employed in Li—S electrochemical cells in accordance with one or more embodiments of the present disclosure.

FIG. 46 is a plot of room temperature electrochemical data at different current rates for nanocomposites with different compositions employed in Li—S electrochemical cells in accordance with one or more embodiments of the present disclosure.

FIG. 47 is a plot of capacity retention data for 100 cycles at 0.2 C for nanocomposites with different compositions employed in Li—S electrochemical cells in accordance with one or more embodiments of the present disclosure.

FIG. 48 is a plot of capacity retention data for 200 cycles at 0.2 C for nanocomposites with different compositions employed in Li—S electrochemical cells in accordance with one or more embodiments of the present disclosure.

FIG. 49 is a plot of specific capacity and capacity retention ratio (Q_{L}/Q_{H}) for a nanocomposite at different cycles in accordance with one or more embodiments of the present disclosure.

FIG. 50 is a plot of specific capacity and capacity retention ratio (Q_{L}/Q_{H}) for a nanocomposite at different cycles in accordance with one or more embodiments of the present disclosure.

FIG. 51 is a plot of specific capacity and capacity retention ratio (Q_{L}/Q_{H}) for a nanocomposite at different cycles in accordance with one or more embodiments of the present disclosure.

FIG. 52 is a simplified schematic of a lithium-sulfur battery.

FIG. 53 is a UV-Vis spectrum of a nanocomposite in accordance with one or more embodiments of the present disclosure.

FIG. 54 is a plot of thermogravimetric analysis data and differential thermal analysis data of a nanocomposite in accordance with one or more embodiments of the present disclosure.

### DETAILED DESCRIPTION

### Definitions

Anode: As used in the present disclosure, the term “anode” refers to the negative electrode of a battery. Oxidation reactions occur at the anode.

Carrier Mobility: As used in the present disclosure, the term “carrier mobility” refers to a metric of how quickly an electron or hole can be transported through a material in the presence of an electric field. For example, an electrode with an increased carrier mobility tends to have an increased conductivity and improved electrochemical properties compared to an electrode with a decreased carrier mobility.

Cathode: As used in the present disclosure, the term “cathode” refers to the positive electrode of a battery. Reduction reactions occur at the cathode.

Capacity, specific capacity, specific charge capacity: As used in the present disclosure, the term “capacity” means the product of the discharge current (for example, in amps (A) or milliamps/milliamperes (mA)) and the discharge time (for example, in hours (h)) for a battery at a given load. For example, in certain embodiments, a “capacity” is expressed in amp-hours (Ah) or milliamp-hours (mAh). As used in the present disclosure, the term “specific capacity” means the product of the discharge current and the discharge time of a battery at a given load for a given weight of electrode material (for example, for a given weight of nanocomposite used as an anode material in a battery). For example, in certain embodiment, a “specific capacity” is expressed in amp-hours per gram (Ah/g) or milliamp-hours per gram (mAh/g). In certain embodiments, “specific capacity” is referred to as “specific discharge capacity.” As used in the present disclosure, the term “specific charge capacity” means the product of the charge current and the charge time for a battery at a given load for a given weight of electrode material (for example, for a given weight of nanocomposite used as an anode material). For example, in certain embodiments, a “specific charge capacity” is expressed in Ah/g or mAh/g.

Charge-discharge cycle, Cycle: As used in the present disclosure, the terms “charge-discharge cycle” and “cycle” refer to the process of charging, discharging, or both a battery. For example, a single “charge-discharge cycle” includes charging and discharging a battery. In certain embodiments, a battery is discharged either fully or partially during a discharge cycle. For example, in some embodiments, 100%, 90%, 80%, 70%, or less of a battery's capacity is discharged during a discharge cycle. In certain embodiments, a battery is charged either fully or partially during a charge cycle. For example, in some embodiments, a battery is charged to 100%, 90%, 80%, 70%, or less of its full capacity during a charge cycle.

Nanocomposite: As used in the present disclosure, the term “nanocomposite” refers to a material that contains at least one nanoparticle and at least one additional agent or ingredient. In some embodiments, a nanocomposite contains a substantially uniform collection of nanoparticles.

Nanoparticle: As used in the present disclosure, the term “nanoparticle” refers a microscopic particle with at least one dimension less than 100 nanometers in size. In some embodiments, a nanoparticle is or includes a metal oxide nanoparticle, metal sulfide nanoparticle, metal nitride nanoparticle, nanoparticle of a metal or metal alloy, silicon nanoparticle, silicon oxide nanoparticle, and the like.

Embodiments disclosed herein generally relate to composites for use in energy storage devices, specifically lithium-sulfur batteries. In particular, embodiments relate to compositions and methods of making nanocomposites for improved properties in lithium-sulfur cathodes.

In one aspect, embodiments disclosed herein relate to an electrode material. The electrode material may include a nanocomposite having from 0.1 to 15 wt. % of a metal oxide, carbon and hexagonal boron nitride (herein after “h-BN”). The electrode may also include sulfur.

### Nanocomposite

Nanocomposites disclosed herein may include a metal oxide. The metal oxide may be a metal oxide nanoparticle. In some embodiments, the metal oxide nanoparticle is selected from the group consisting of Co₃O₄, Fe₂O₃, SnO₂, and combinations thereof. In some embodiments, the metal oxide nanoparticle may be Co₃O₄. In some embodiments, the metal oxide nanoparticle may be Fe₂O₃. In some embodiments, the metal oxide nanoparticle may be SnO₂. In one or more embodiments, the metal oxide may include CoO. In some embodiments, nanocomposites may include Co₃O₄ and CoO.

A metal oxide may be present in the nanocomposites any suitable amount. In one or more embodiments, the nanocomposite may include from 0.1 to 15 wt. % of the metal oxide. For example, the nanocomposite may have a lower limit of any of 0.1, 1.0, 2.0, 3.0, 4.0 or 5.0 wt. % (weight percent) of metal oxide, and an upper limit of any of 15.0, 12.0, 10.0, or 7.0 wt. % of metal oxide, where any lower limit may be used in combination with any mathematically compatible upper limit.

Nanocomposites disclosed herein may include carbon. In one or more embodiments, the carbon is selected from the group consisting of graphene, graphite and combinations thereof. In some embodiments, the carbon may be graphene. In some embodiments, the carbon may be graphite. Nanocomposites disclosed herein may include from 85 to 99.9 wt. % of carbon and h-BN. For example, the nanocomposite may have a lower limit of 85.0, 88.0, 90.0 or 93.0 wt. % of carbon and h-BN and an upper limit of 99.9, 99.0, 98.0, 97.0, 96.0 or 95.0 wt. % of carbon and h-BN, where any lower limit may be used in combination with any mathematically compatible upper limit.

Nanocomposites disclosed herein may include any suitable amount of carbon. For example, the nanocomposite may include carbon in amount ranging from a lower limit of 5, 10, 20, 30 or 40 wt. % of the nanocomposite, to an upper limit of 90, 80, 70, 60, 55 or 50 wt. % of the nanocomposite, where any lower limit may be used in combination with any mathematically compatible upper limit.

Nanocomposites disclosed herein may include any suitable amount of h-BN. For example, the nanocomposite may include h-BN in an amount ranging from a lower limit of 5, 10, 20, 30 or 40 wt. % of the nanocomposite, to an upper limit of 90, 80, 70, 60, 55 or 50 wt. % of the nanocomposite, where any lower limit may be used in combination with any mathematically compatible upper limit.

Nanocomposites disclosed herein may include any suitable ratio of carbon to h-BN. In some embodiments, the ratio of carbon to h-BN may be from 1:9 to 9:1. In some embodiments, the ratio of carbon to h-BN may have a lower limit of 1:9, or 3:7, and an upper limit of 7:3, or 9:1, where any lower limit can be used in combination with any upper limit. In some embodiments, the amount of carbon may have a lower limit of 10, 20, 30, or 40 wt. % based on the total amount of carbon and h-BN in the nanocomposite, and an upper limit of 90, 80, 70 or 60 wt. % based on the total amount of carbon and h-BN in the nanocomposite, where any lower limit may be used in combination with any mathematically compatible upper limit. In some embodiments, the amount of h-BN may have a lower limit of 10, 20, 30, or 40 wt. % based on the total amount of carbon and h-BN in the nanocomposite, and an upper limit of 90, 80, 70 or 60 wt. % based on the total amount of carbon and h-BN in the nanocomposite, where any lower limit may be used in combination with any mathematically compatible upper limit.

### Method of Making a Nanocomposite

In one aspect, a method of making a nanocomposite may include making a precursor mixture and then forming the nanocomposite from the precursor mixture. The method may include, milling a metal precursor, carbon, and h-BN to make a precursor mixture. The metal precursor may be any suitable precursor that when milled and heated according to the methods disclosed herein, results in a metal oxide being formed. The metal precursor may be a metal salt, such as metal halides, metal acetates, metal hydroxides, metal sulfates, metal nitrates, and metal hydrates of the same. The metal salts may be salts of cobalt, tin, iron and combinations thereof. For example, in some embodiments, the metal salt is cobalt (II) acetate or a hydrate of the same. In some embodiments the metal salt is tin tetrachloride (SnCl₄). In some embodiments, the metal salt is ferric chloride (FeCl₃).

The method may further include heating the precursor mixture to a predetermined temperature in the presence of oxygen to form a nanocomposite. During the heating step, the metal salt may be converted to a metal oxide.

In one or more embodiments, the milling step may include ball milling. The ball milling may include high energy ball milling or low energy ball milling.

Ball milling may be performed for any suitable time to obtain a homogeneous precursor mixture. In certain embodiments, the milling time is less than 1 hour. In certain embodiments, the milling time is at least 20 minutes. In certain embodiments, the milling time is about 20 to 90 minutes. In certain embodiments, the milling time is about 30 to 90 minutes. In certain embodiments, the milling time is about 30 to 60 minutes. In certain embodiments, the milling time is about 1 to 3 hours. In certain embodiments, the milling time is about 1 to 5 hours. In certain embodiments, the milling time is about 1 to 7 hours. In certain embodiments, the milling time is about 3 to 5 hours. In certain embodiments, the milling time is about 3 to 7 hours. In certain embodiments, the milling time is about 3 to 9 hours. In certain embodiments, the milling time is about 5 to 10 hours. In certain embodiments, the milling time is about 7 to 12 hours. In certain embodiments, the milling time is about 10 to 24 hours.

Ball milling may be performed at any suitable speed to obtain a homogeneous precursor mixture. In certain embodiments, the milling speed is greater than 500 rpm (revolutions per minute). In certain embodiments, the milling speed is about 500 to 2500 rpm. In certain embodiments, the milling speed is about 1000 to 2500 rpm. In certain embodiments, the milling speed is about 1000 to 2000 rpm. In certain embodiments, the milling speed is about 1200 to 1800 rpm. In certain embodiments, the milling speed is about 1275 to 1725 rpm.

In some embodiments, low-energy ball milling may be used. In one or more embodiments, the low energy ball milling speed is from about 400 to 800 rpm. In some embodiments, the milling speed may have a lower limit of one of about 400, 450, 500, 550, and 600 rpm and an upper limit of one of about 650, 700, 750 and 800, where any lower limit may be combined with any mathematically compatible upper limit.

In some embodiments, the milling step is followed by a heating step (thermal decomposition) to form a nanocomposite. The heating step includes heating the precursor mixture to a predetermined temperature. In some embodiments, the heating step may be performed in oxygen in order to calcine the precursor mixture. In certain embodiments, the predetermined temperature is about 200° C. to 500° C. In certain embodiments, the predetermined temperature is about 300° C. to 750° C. In certain embodiments, the predetermined temperature is about 325° C. to 500° C. In certain embodiments, the predetermined temperature is about 325° C. to 375° C. In certain embodiments, the predetermined temperature is about 325° C. to 350° C. In certain embodiments, the predetermined temperature is about 340° C. to 360° C. In certain embodiments, the predetermined temperature is about 345° C. to 355° C. In certain embodiments, the predetermined temperature is about 350° C. to 375° C. In certain embodiments, the predetermined temperature is about 350° C. to 550° C. In certain embodiments, the predetermined temperature is about 500° C. to 1000° C. In certain embodiments, the predetermined temperature is about 500° C. to 750° C.

In certain embodiments, an oven used for the heating step is heated at a rate of about 1 to 15° C./min until the predetermined temperature is reached. In certain embodiments, the heating rate is about 1 to 10° C./min until the predetermined temperature is reached. In certain embodiments, the heating rate is about 1 to 7° C./min until the predetermined temperature is reached. In certain embodiments, the heating rate is about 1 to 5° C./min until the predetermined temperature is reached. In certain embodiments, the heating rate is about 1 to 3° C./min until the v temperature is reached. In certain embodiments, the heating rate is about 3 to 15° C./min until the v temperature is reached. In certain embodiments, the heating rate is about 3 to 10° C./min until the predetermined temperature is reached. In certain embodiments, the heating rate is about 3 to 7° C./min until the v temperature is reached. In certain embodiments, the heating rate is about 5 to 20° C./min until the v temperature is reached. In certain embodiments, the heating rate is about 7 to 13° C./min until the predetermined temperature is reached.

In certain embodiments, the heating step is performed for about 1 to 10 hours, meaning once the predetermined temperature is reached, the mixture is held at the predetermined temperature for a period of time. In certain embodiments, the heating step is performed for about 1 to 7 hours. In certain embodiments, the heating step is performed for about 1 to 5 hours. In certain embodiments, the heating step is performed for about 3 to 7 hours. In certain embodiments, the heating step is performed for about 2 to 5 hours.

### Electrode Material

In one aspect, embodiments disclosed herein relate to an electrode material. In some embodiments, the electrode material may include the previously-described nanocomposite and sulfur. Sulfur may be present in the electrode any suitable amount. For example the electrode may include a lower limit of 60, 70, 75 or 80 wt. % sulfur, and an upper limit of 98, 95, 92 or 90 wt. % sulfur, where any lower limit may be used in combination with any mathematically compatible upper limit. The electrode material may be suitable for use in lithium-sulfur batteries.

In one or more embodiments, an electrode may also include one or more additives. In certain embodiments, additives include, among other things, conductive agents and binding agents. In certain embodiments, a conductive agent is selected from the group consisting of carbon black, C-NERGY™ Super C65®, C-NERGY™ SFG6L, Super P®, a carbon nanotube-based material and combinations of the same. In certain embodiments, a binding agent is polyvinylidene fluoride, a polyvinylidene fluoride resin (for example, Kynar® HSV900), or styrene butadiene. In certain embodiments, a binding agent is polyvinylidene fluoride. In certain embodiments, a binding agent is a polyvinylidene fluoride resin. In certain embodiments, one or more additives include an acid. In certain embodiments, an additive is oxalic acid. In certain embodiments, a solvent is a mixture of dimethyl sulfoxide (DMSO) and ethanol. In certain embodiments, a mixture of DMSO and ethanol is a 1:1 mixture by volume. In certain embodiments, a mixture of DMSO and ethanol is a 2:1 mixture by volume. In certain embodiments, a mixture of DMSO and ethanol is a 1:2 mixture by volume. In certain embodiments, a solvent is N-methyl-2-pyrrolidone (NMP).

A summed weight percent of additive(s) in the electrode formulation is in a range from 5% to 50%. For example, in certain embodiments, the amount of a binding agent in an electrode is zero, or the amount of conductive additive in an electrode is zero. Alternatively, in certain embodiments, an electrode includes both a binding agent and a conductive additive. In certain embodiments, a conductive agent makes up about 1% to about 25% of an electrode coating. In certain embodiments, a conductive agent makes up about 5% to about 20% of an electrode coating. In certain embodiments, a conductive agent makes up about 5% to about 15% of an electrode coating. In certain embodiments, a binding agent makes up about 1% to about 25% of an electrode coating. In certain embodiments, a binding agent makes up about 5% to about 20% of an electrode coating. In certain, embodiments, a binding agent makes up about 5% to about 15% of an electrode coating.

### Method of Making an Electrode

As previously described, in one aspect, embodiments disclosed herein relate to a method of making an electrode. The method may include mixing the previously-described nanocomposite with sulfur to create an electrode mixture, and then forming an electrode from the electrode mixture.

In some embodiments, after the heating step, the nanocomposite is mixed with sulfur to create an electrode mixture. In some embodiments, the mixing step may include ball milling. In certain embodiments, the mixture may be ball milled for about 30 to 90 minutes. In certain embodiments, the mixture may be ball milled for about 30 to 60 minutes. In certain embodiments, the mixture may be ball milled for about 60 to 90 minutes. In certain embodiments, the mixture may be ball milled for about 1 to 3 hours. In certain embodiments, the mixture may be ball milled for about 1 to 5 hours.

In one or more embodiments, electrode materials are formed by blending the electrode mixture with one or more of the previously-described additives in a solvent.

In an illustrative embodiment, an electrode material is fabricated by combining and mixing three solutions. In an illustrative embodiment, a first solution includes a conductive agent dispersed in a solvent, a second solution includes a binding agent dispersed in a solvent, and a third solution includes a nanocomposite dispersed in a solvent. In certain embodiments, combined solutions are mixed with a FlackTek SpeedMixer™. In certain embodiments, combined solutions are mixed with a FlackTek SpeedMixer™, followed by mixing with a Primix Model 40-L rotor-stator mixer.

In one or more embodiments, a solution is blended to obtain a homogenous slurry, which is applied to a foil substrate and allowed to dry. In some embodiments, a foil substrate acts as a current collector. In certain embodiments, a foil substrate is a copper foil substrate. In certain embodiments, a foil substrate is an aluminum substrate. In an illustrative embodiment, a slurry is applied to a foil substrate to form a 50 to 300 μm film, and the film is dried under vacuum. The film may have any appropriate thickness to achieve a desired sulfur loading in a lithium-sulfur battery. In some embodiments, the electrode thickness may have a lower limit of any of 50, 75, 100, 125, 150, 200 μm, and an upper limit of any of 300, 275, 250, or 225 μm, where any lower limit may be used in combination with any mathematically compatible upper limit. In certain embodiments, a film is dried at a temperature of about 60 to 110° C. In certain embodiments, a film is dried at a temperature of about 60 to 90° C. In certain embodiments, a film is dried at a temperature of about 80 to 130° C.

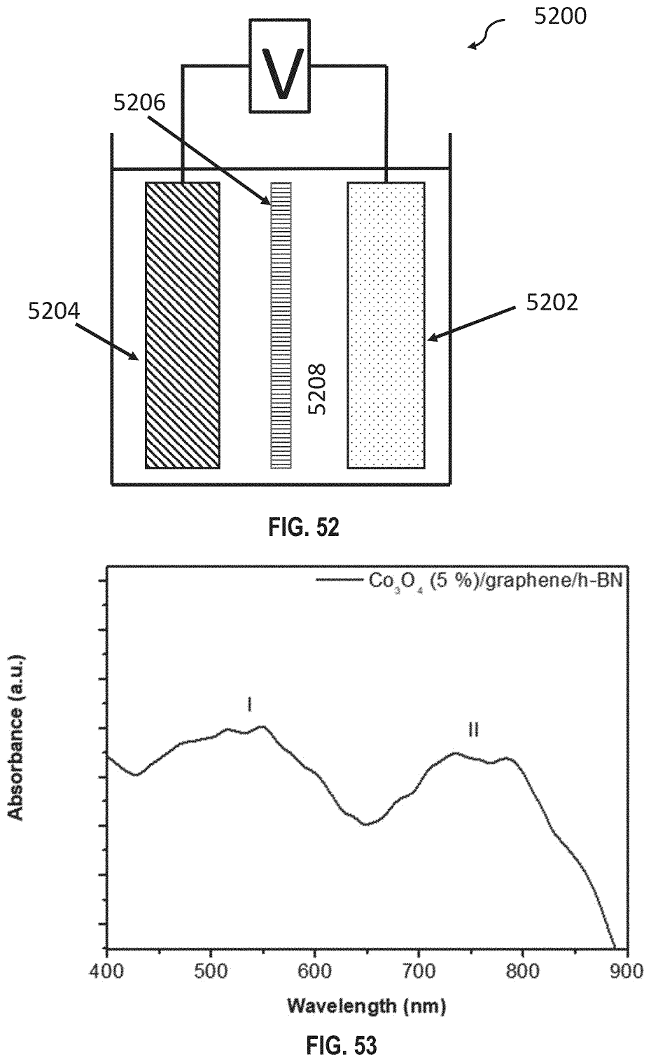

In another aspect, embodiments disclosed herein relate to a lithium-sulfur battery having an anode, a cathode, a separator, and an electrolyte. In some embodiments, the cathode includes the previously-described electrode material, i.e., the nanocomposite and sulfur. FIG. 52 shows a lithium-sulfur battery 5200 having a cathode 5202, an anode 5204, a separator 5206 and an electrolyte 5208.

In lithium-sulfur battery 5200, the cathode 5202 may include the previously-described electrode films. In lithium-sulfur battery 5200, an anode 5204 may be, in some embodiments, for example, lithium metal. In some embodiments, the electrolyte 5208 may include, for example, one or more lithium salts dissolved in one or more organic solvents. For example, in certain embodiments, one or more lithium salts may be present in concentrations of about 0.05 mol % to about 1 mol %. In certain embodiments, one or more lithium salts are present at a concentration of about 0.1 mol %. In certain embodiments, lithium salts include bis(trifluoromethane)sulfonimide lithium salt (LiTFSI) or lithium nitrate. For example, organic solvents include 1,2-dimethoxyethane (DME) or 1,3-dioxolane (DOL). The separator may be, in some embodiments, a polypropylene membrane that is placed between an anode and a cathode.

In some embodiments, the lithium-sulfur battery may include a cathode with a thickness sufficient to achieve an appropriate sulfur loading. For example, the cathode may have a thickness of from 50 to 300 μm (micrometers). In some embodiments, the cathode thickness may have a lower limit of any of 50, 75, 100, 125, 150, 200 μm, and an upper limit of any of 300, 275, 250, or 225 μm, where any lower limit may be used in combination with any mathematically compatible upper limit.

In some embodiments, the lithium-sulfur battery includes a cathode having a sulfur loading sufficient to achieve acceptable electrochemical performance on cycling. Sulfur loading is calculated as a density of sulfur on the cathode in milligrams per centimeter squared (mg/cm²). For example, the cathode may have a sulfur loading of at least 1.8, 1.9, 2.0, 2.1 or 2.2 mg/cm².

### Battery Properties

In some embodiments, the lithium-sulfur battery may achieve an acceptable sulfur utilization. Sulfur utilization may be calculated based on any cycle number. Unless otherwise indicated, the sulfur utilization values disclosed herein are calculated on the fourth cycle. For example, in some embodiments, the sulfur utilization of the lithium-sulfur battery may be at least 65% or at least 75% or at least 80% or at least 85% on the fourth cycle.

In some embodiments, the lithium sulfur battery may achieve high specific capacity. In one or more embodiments, at a C rate of 0.1 C at ambient temperature, the lithium sulfur battery may achieve a discharge capacity of at least about 450, 475, 500, 515, 520, 525, 530, or 540 mAh/g (milliamp hours per gram) at the 5^{th} cycle. In one or more embodiments, at a C rate of 0.1 C at 50° C., the lithium sulfur battery may achieve a discharge capacity of at least about 700, 725, 750, 775, 790, 795, 800, or 805 mAh/g at the 5^{th} cycle. In one or more embodiments, at a C rate of 0.1 C at 100° C., the lithium sulfur battery may achieve a discharge capacity of at least about 550, 575, 600, 625, 650, 675, 680, 685, or 690 mAh/g at the 5^{th} cycle.

In some embodiments, the lithium-sulfur battery may achieve good cycling capability. For example, at a cycling rate of 0.2 C at room temperature, after 100 cycles, at least 60%, 65%, 70%, 75%, 80% or 85% capacity may be retained. In some embodiments, at a cycling rate of 0.2 C at room temperature, after 200 cycles, at least 60%, 65%, 70%, 75%, 80% or 85% capacity may be retained. In some embodiments, at a cycling rate of 0.2 C at room temperature, after 250 cycles, at least 60%, 65%, 70%, 75%, 80% or 85% capacity may be retained.

Embodiments of the present disclosure may provide at least one of the following advantages. When utilized as a cathode in a lithium-sulfur battery, the electrode compositions disclosed herein may provide, for example, improved specific capacity, improved rate performance, and improved sulfur utilization over cathode that to not include the compositions disclosed herein. These improvements may be realized at room temperature and elevated temperature conditions.

For example, in certain embodiments, batteries (for example, lithium-sulfur batteries) described in the present disclosure can be used to power downhole equipment, which is used to measure conditions inside oil wells or during other oil operations, for example, during oil discovery and recovery. Oil operations, for example, oil discovery and recovery, rely on use of equipment subjected to particularly harsh conditions, for example, increased temperatures and increased pressures. Previous equipment suffered from more frequent breakdown and decompositions due to conditions encountered in an oil well during routine oil operations. Further, previous equipment required additional safety equipment to relieve high pressure in a battery (to prevent thermal runaway). Such devices, however, are not 100% effective or completely reliable. Applicant discovered that, certain nanocomposites and batteries, which use certain nanocomposites as electrode materials, exhibit improved properties that are not found in previous nanocomposites and batteries, thereby obviating the need for certain safety devices, increasing efficiency of certain oil operation equipment.

For example, in some embodiments, downhole equipment includes pressure and temperature sensors for measuring the pressure and temperature, respectively, in an oil well during drilling and oil recovery. For example, conditions in an oil well can be variable with temperatures in a range from 80° C. to 150° C. or greater. It is useful for equipment to reliably monitor these conditions to enable drilling and oil recovery to be performed more effectively and to detect potential safety concerns (for example, caused by sudden increases in temperature, pressure, or both). In particular, it is beneficial to identify at an early stage any risk of damage to equipment to thereby prevent or reduce the likelihood of human injury. Batteries described in the present disclosure have, in some embodiments, improved safety, electrochemical properties, and stability compared to those of conventional batteries used to power downhole equipment. In some embodiments, lithium-sulfur batteries described in the present disclosure provide lightweight power sources with an improved energy density, cycle life, and structural stability relative to batteries employing conventional electrode materials.

In certain embodiments, batteries described in the present disclosure obviate (or decrease) the need for complex engineering techniques and safety devices that may otherwise be used in an attempt to limit the likelihood of thermal runaway. For example, while safety devices may relieve high pressure in a battery to help prevent thermal runaway, such devices are not 100% effective or completely reliable. Instead, rechargeable batteries described in the present disclosure provide a more cost-effective and safer option for preventing thermal runaway without relying on complex safety devices.

### EXAMPLES

### Example 1: Preparation of Co₃O₄/h-BN/Graphene Nanocomposites

Cobalt (II) acetate tetrahydrate (0.150 g) (SRL), boron nitride micropowder (0.855 g) (Graphene Supermarket), and graphene nanoplatelets (1.995 g) (XG Sciences) were combined in a SPEX SamplePrep 8000M Mixer/Mill ball milling apparatus equipped with four 0.25 inch steel balls and two 0.5 inch steel balls. The mixture was ball-milled for 1 hour at a speed of 1725 rpm. The resulting powder was calcined in an oven at a temperature of 350° C. for 4 hours with a heating rate of 7° C./min. Nanocomposites with four different Co₃O₄ contents were prepared. The resulting nanocomposites included 5, 60, 85 or 90 wt. % of Co₃O₄.

### Example 2: Preparation of Co₃O₄, Co₃O₄/Graphene and Co₃O₄/h-BN Nanocomposites

The method disclosed in Example 1 was used to prepare samples with compositions of pure Co₃O₄, Co₃O₄/graphene and Co₃O₄/h-BN. Specifically, to prepare a sample of pure Co₃O₄, 3.0 g of cobalt (II) acetate tetrahydrate was ball milled and heated as described in Example 1. To prepare Co₃O₄/graphene, 2.55 g of cobalt (II) acetate tetrahydrate was ball milled with 0.45 g of graphene and heated as described in Example 1. To prepare Co₃O₄/h-BN 2.55 g of cobalt (II) acetate tetrahydrate was ball milled with 0.45 g of h-BN and heated as described in Example 1.

### Example 3: Preparation of Co₃O₄/h-BN/Graphene Nanocomposites at Different Graphene: h-BN Ratios

Samples were prepared according to Example 1, with 2.85 g of graphene and h-BN. The ratios of graphene: h-BN was varied and samples with ratios of 3:7, 7:3 and 9:1 were prepared for Co₃O₄ contents of 60 wt. % and 90 wt. %. In addition, a sample having only graphene and h-BN (i.e., no Co₃O₄) was prepared with a graphene: h-BN ratio of 7:3.

### Example 4: Preparation of Co₃O₄/h-BN/Graphite Nanocomposites

Samples were made according to the method of Example 1, however graphite (Merck, fine powder extra pure) was used in place of graphene. For these samples, 5 wt. % Co₃O₄ was used, and the ratio of graphite: h-BN was 7:3.

### Example 5: Preparation of h-BN/Graphene Nanocomposites with Iron and Tin Oxides

Nanocomposites were made according to the method of Example 1, however, instead of using cobalt (II) acetate tetrahydrate, tin hydroxide (Sn(OH)₂) and ferric chloride (FeCl₃) were ball milled to make composites having SnO₂ and Fe₂O₃. A similar procedure to Example 1 was followed, however, in order to ball mill the tin precursor, sodium hydroxide was reacted with to SnCl₄ via hydrothermal synthesis order to precipitate the precursor for use as a solid. Then tin hydroxide was ball milled according to the method of Example 1. Composites including 5 wt. % of Fe₂O₃ and SnO₂ were prepared.

### Example 6: Preparation of Co₃O₄/h-BN/Graphene Nanocomposites at Different Calcination Temperatures

Nanocomposites were made according to the method of Example 1, but calcination temperatures of 350, 550 and 750° C. were used. The calcination time of 4 hours and the heating rate of 7° C./min were the same for all calcination temperatures.

### Example 7: Low-Energy Ball Milling Preparation of Co₃O₄/h-BN/Graphene Nanocomposites

1.25 g of cobalt (II) acetate tetrahydrate (SRL), 7.125 g of boron nitride micropowder (Graphene Supermarket), and 16.625 g graphene nanoplatelets (XG Sciences) were combined in a Planetary Mill Pulverisette 5 premium ball milling apparatus equipped with 25 stainless steel balls with a diameter of 20 mm (millimeters). The mixture was ball-milled for 1 hour at a speed of 450 rpm. The resulting powder was calcined in an oven at a temperature of 350° C. for 4 hours with a heating rate of 7° C./min.

### Example 8: Preparation of Sulfur-Containing Nanocomposites

Nanocomposites prepared according to Examples 1-7 were mixed with 70 wt. % elemental sulfur and ball-milled for 45 minutes in a SPEX SamplePrep 8000M Mixer/Mill equipped with four 0.25 inch steel balls and two 0.5 inch steel balls at a speed of 1725 rpm.

### Example 9: X-Ray Diffraction (XRD) of Nanocomposites

To study the crystallinity of the nanocomposites, X-ray diffraction (XRD) powder patterns of the nanocomposites were measured at 30 kV and 40 mA using a Rigaku MiniFlex 600 X-ray diffractometer (Japan) equipped with Cu Kα radiation (1.54430 Å).

### Example 10: Thermal Properties of Nanocomposites

Thermogravimetric analysis (TGA) was performed using an STA 7200 thermogravimetric analysis system to determine thermal stability of nanocomposites at temperatures from 25° C. to 500° C. with a heating rate of 10° C./min. TGA was performed on nanocomposites both before and after calcination.

### Example 11: Fabrication of Electrodes for Lithium-Sulfur Batteries

Working electrodes for a lithium-sulfur battery were fabricated by manually mixing 80 wt % of each sulfur-containing nanocomposite prepared in accordance with Example 8 with 10 wt % of conductive agent (Super P) and 10 wt % of binding agent (PVDF) in N-methyl-2-pyrrolidone (NMP). The mixtures were processed using a homogenizer or a wet ball-milling method to obtain a homogenous slurries. The resultant slurries were then uniformly pasted onto aluminum foil substrates with a thickness of 200 μm and dried at 80° C. under vacuum.

### Example 12: Electrochemical Testing

Coin-cells were built to test the electrochemical performance of the electrodes. The cathode films described in Example 11 were cut to a diameter of 15 mm to achieve a sulfur loading of 2.66 mg/cm² with an electrode thickness of 200 μm. Lithium metal was used as the anode, and a polypropylene microporous film (Celgard 2400) was used as the separator. The electrolyte was a 1 M (moles/liter) solution of bis(trifluoromethanesulfony)imide lithium (LiTFSi) and 1 wt. % of lithium nitrate (LiNO₃) in 1,2-dimethoxyethane (DME) and 1,3-dioxolane (DOL) (1:1, v/v).

Ambient temperature electrochemical tests were performed using a BST8-300-CST from MTI Corporation. Elevated temperature electrochemical tests were performed using a Gamry Reference 3000 Potentiostat/Galvanostat/ZRA from Gamry Instruments. The electrochemical cell was cycled between 1.8 and 2.6 V at current rates of 0.1 C, 0.2 C, 0.3 C, and 0.5 C. Elevated temperature studies were conducted using a bomb calorimeter vessel connected to the positive and negative terminal of the battery to the two electrodes of the vessel. The battery was then put inside the bomb calorimeter and the temperature was raised and left until temperature reaches equilibrium. The electrochemical measurements were then performed by connecting the bomb calorimeter vessel to the electrochemical testing system.

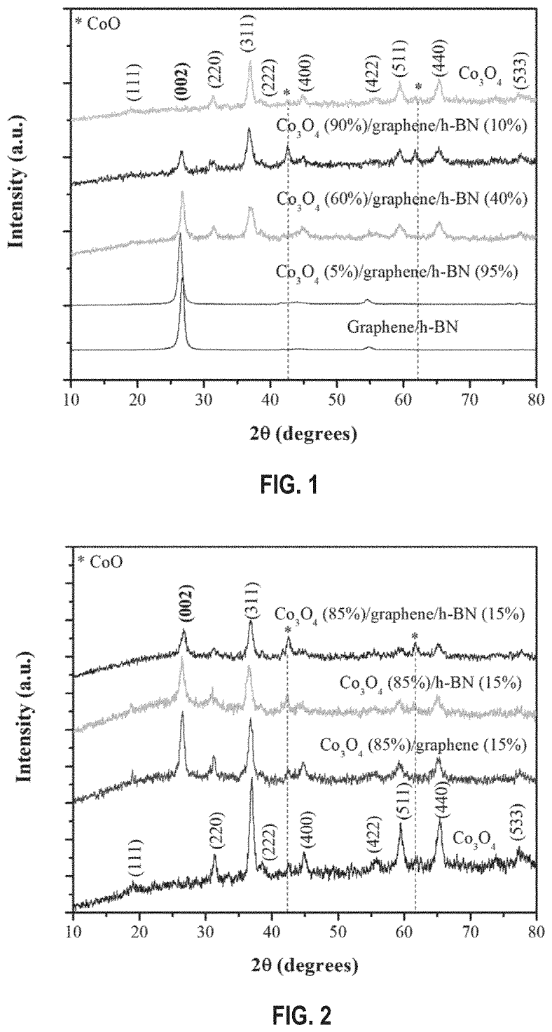

FIG. 1 shows XRD patterns of samples made according to Examples 1, 2 and 3. Specifically, the bottom pattern is graphene/h-BN made according to Example 3, the three middle XRD patterns are Co₃O₄/h-BN/graphene nanocomposites having 5, 60 and 90 wt. % (from bottom to top, respectively) made according to Example 1, and the top pattern is Co₃O₄ made according to Example 2. Characteristic diffraction peaks were identified for Co₃O₄ and hexagonal boron nitride in the XRD patterns for Co₃O₄/graphene/h-BN nanocomposites. The peak located at 26.3° corresponds to the (002) plane from both graphene and h-BN. The diffraction peaks of Co₃O₄ were indexed to those of pure Co₃O₄ with a cubic spinel structure (Joint Committee on Powder Diffraction Standards (JCPDS) card no. 76-1802). The peaks observed at 19.2°, 31.4°, 36.9°, 44.76°, 59.53°, 65.44°, and 78.5° correspond to the (111), (220), (311), (400), (422), (511), (440), and (533) planes of Co₃O₄ phase, respectively. The diffraction peaks at 42.65° and 62.15° (labeled with *) can be indexed to the (200) and (220), respectively, of the CoO phase.

As shown, the sample having only 5 wt. % Co₃O₄ does not have strong peaks indicative of Co₃O₄. This may indicate that very small nanoparticles were well-dispersed in the graphene/h-BN, and thus were not able to be detected by the XRD. This might also be due to the Co₃O₄ diffusion into the graphene/h-BN. It may also be a result of the low relative crystallinity of the Co₃O₄ phase as compared to the highly crystalline graphene/h-BN phases. It can be seen, however, that there was a slight downshift in the peak position of the (002) peak from graphene/h-BN, indicating an expansion in the interlayer distance of the (002) peak due to Co₃O₄ intercalation in the sample with 5 wt. % Co₃O₄.

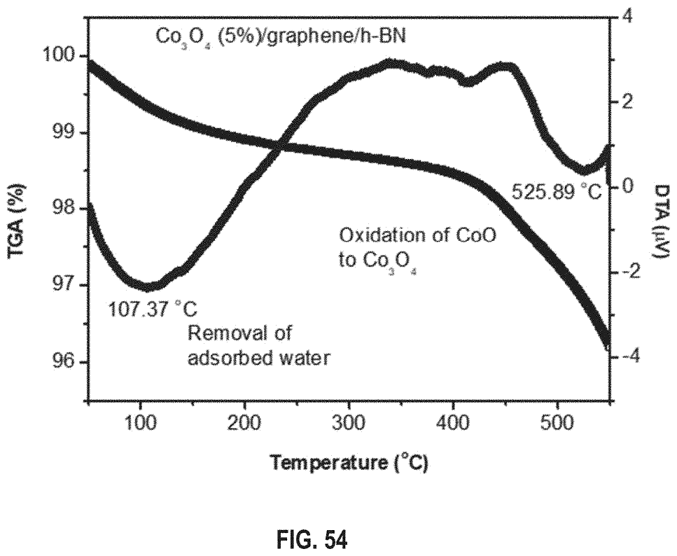

The presence of cobalt oxides may be observed using UV-Vis spectroscopy. FIG. 53 shows UV-Vis data for a sample of Co₃O₄/h-BN/graphene nanocomposites having 5 wt. % Co₃O₄. The peaks around 550 and 800 nm are indicative of cobalt oxides. Furthermore, the presence of the CoO phase may be observed via thermal decomposition studies. FIG. 54 shows thermal gravimetric analysis (TGA) and differential thermal analysis data for a sample of Co₃O₄/h-BN/graphene nanocomposites having 5 wt. % Co₃O₄. The DTA peak observed at about 525° C. is due to oxidation of the CoO phase to Co₃O₄.

FIG. 2 shows XRD patterns for Co₃O₄, Co₃O₄/graphene, Co₃O₄/h-BN, and Co₃O₄/graphene/h-BN from bottom to top, respectively. The samples having graphene and/or h-BN have a Co₃O₄ content of 85 wt. %. As shown, the peaks from the CoO phase (labeled with *) are more intense in Co₃O₄/h-BN and Co₃O₄/graphene/h-BN composites, implying the facilitation of CoO formation in the presence of h-BN. Without being bound by any particular mechanism or theory, it is believed that nitrogen favors the nucleation and growth of CoO that are anchored on the quaternary nitrogen through its coordination and electrostatic interactions with the Co²⁺ ions.

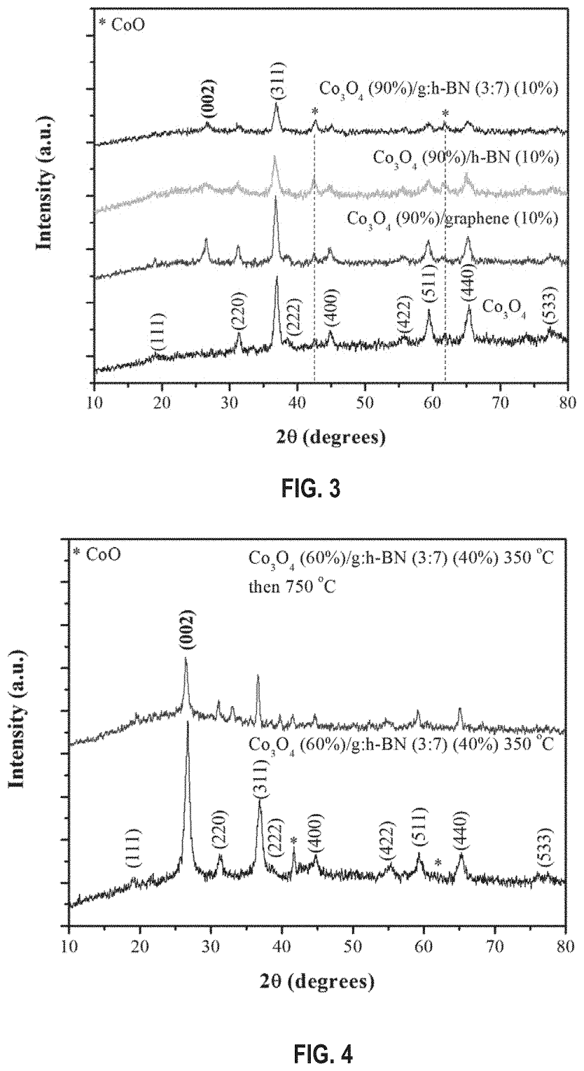

FIG. 3 shows similar samples as compared to FIG. 2, however the Co₃O₄ content for the samples having Co₃O₄ is 90 wt. %. Similar trends are seen for the CoO phase in samples that have h-BN.

FIG. 4 shows two samples of the same composition at two different calcinations, according to Example 11. The compositions are prepared according to Example 1, and have 60 wt. % Co₃O₄. The bottom sample was calcined at 350° C., and the top sample was calcined at 750° C. A slight decrease in the peaks attributed to CoO is seen at the higher calcination temperature.

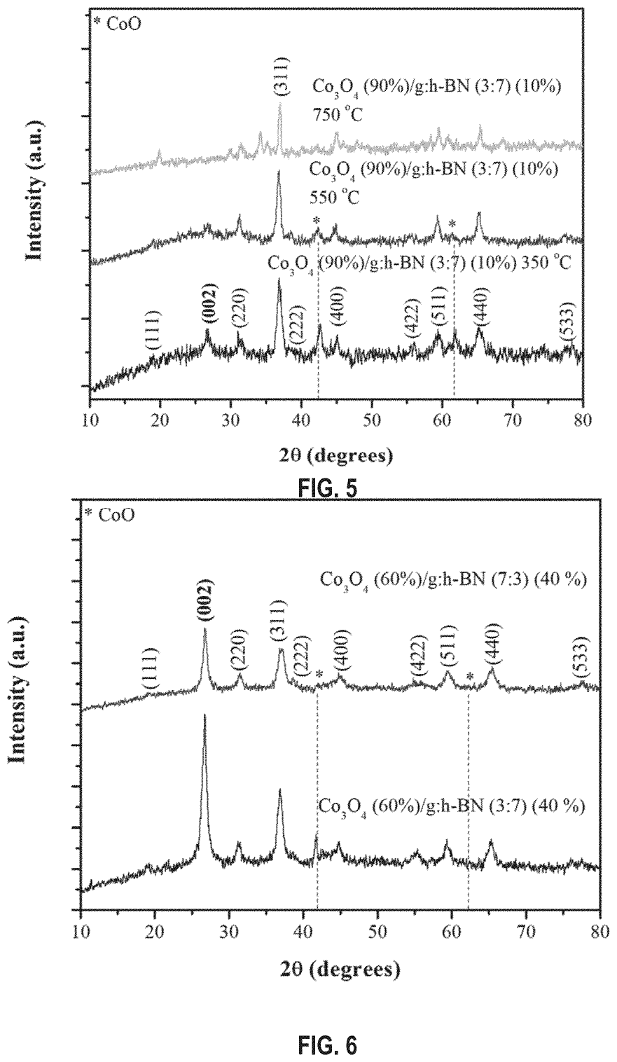

FIG. 5 shows three samples of the same composition at three different calcinations, according to Example 11. The compositions are prepared according to Example 1, and have 90 wt. % Co₃O₄. The samples were calcined at 350° C., 550° C. and 750° C., from bottom to top, respectively. As shown, the intensity of the peaks attributed to CoO decreases with increasing calcination temperature.

FIG. 6 shows two samples prepared according to Example 3. Both samples have a Co₃O₄ content of 60 wt. %. The bottom sample has a graphene: h-BN ratio of 3:7 and the top sample has a graphene: h-BN ratio of 7:3. As shown, the sample with higher h-BN content has peaks attributed to CoO with higher intensity.

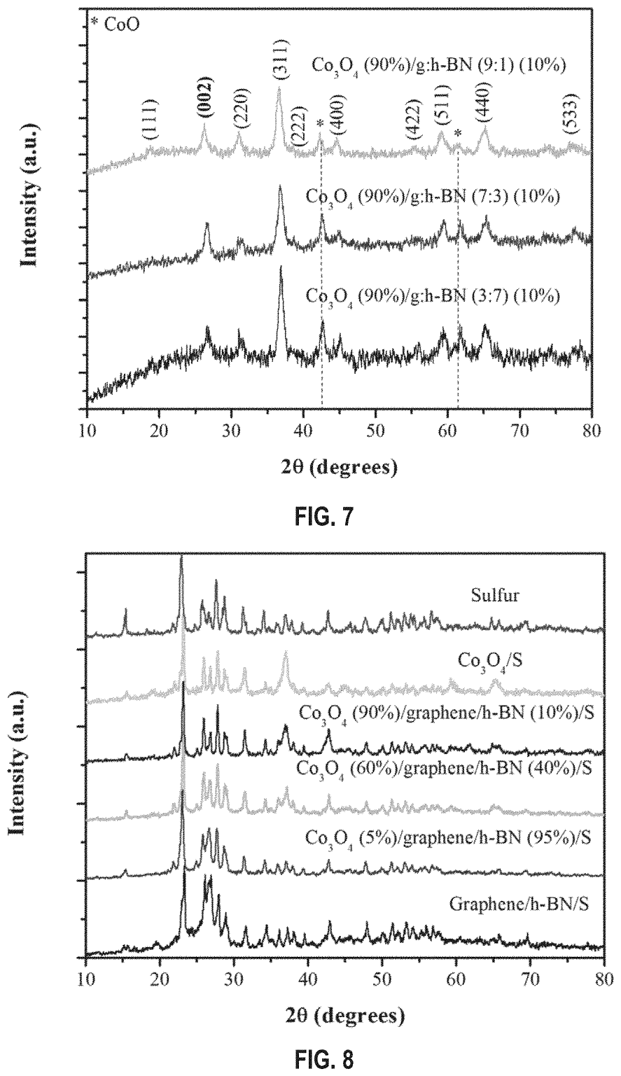

FIG. 7 shows three samples prepared according to Example 3. All samples have a Co₃O₄ content of 90 wt. %. The bottom sample has a graphene: h-BN ratio of 3:7, the middle sample has a graphene: h-BN ratio of 7:3, and the top sample has a graphene: h-BN ratio of 9:1. As shown, the samples with higher h-BN content have peaks attributed to CoO with higher intensity.

Without being bound by any particular mechanism or theory, it is believed that the formation of a catalytic CoO phase and the presence of (111) exposed planes of Co₃O₄ may contribute to increased catalytic activity of the cobalt species, leading to improved electrochemical properties in a lithium-sulfur battery.

FIG. 8 shows XRD patterns of sulfur-containing nanocomposites made according to Example 11. From bottom to top, the samples are graphene/h-BN/sulfur, Co₃O₄/graphene/h-BN/sulfur with 5 wt. % Co₃O₄ in the Co₃O₄/graphene/h-BN nanocomposite, Co₃O₄/graphene/h-BN/sulfur with 60 wt. % Co₃O₄ in the Co₃O₄/graphene/h-BN nanocomposite, Co₃O₄/graphene/h-BN/sulfur with 90 wt. % Co₃O₄ in the Co₃O₄/graphene/h-BN nanocomposite, Co₃O₄/sulfur, and elemental sulfur. The elemental sulfur exhibits a number of crystalline peaks with three prominent peaks at 23.1°, 25.9°, and 27.8° which can be indexed as the (222), (026) and (311) planes of the fddd orthorhombic structure of sulfur. (Joint Committee on Powder Diffraction Standards (JCPDS) card no. 77-0145). The rest of the samples also contain the peaks characteristic of sulfur, but also maintain the graphene/h-BN and Co₃O₄ peaks. This is indicative that no phase transformations occur during the ball milling process to make the sulfur-containing nanocomposites.

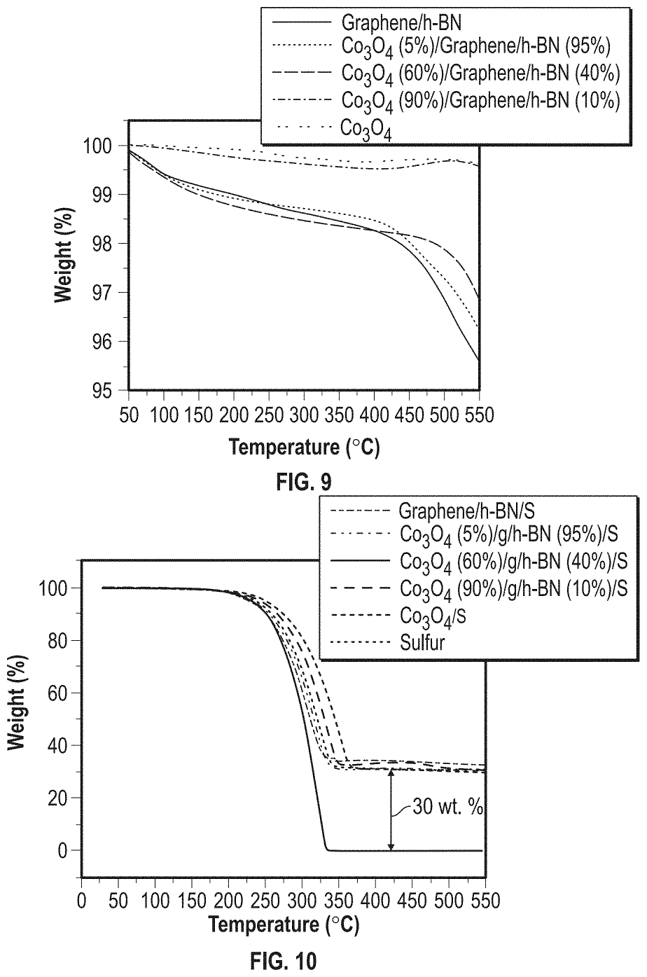

FIG. 9 shows TGA data for the samples in FIG. 1. The data shows that all samples have good thermal stability.

FIG. 10 shows TGA data for the samples in FIG. 8 (sulfur-containing composites). The significant weight loss observed between 200 and 400° C. may be attributed to the sublimation of sulfur. The sublimation of sulfur in the Co₃O₄-containing composites is complete is about 360° C. This is higher than temperature at which the sublimation is complete for elemental sulfur. A shift of the TGA curve to higher temperatures was observed with increasing the content of Co₃O₄. This may suggest a binding interaction between sulfur and the composite, which would require additional energy to sublimate the sulfur.

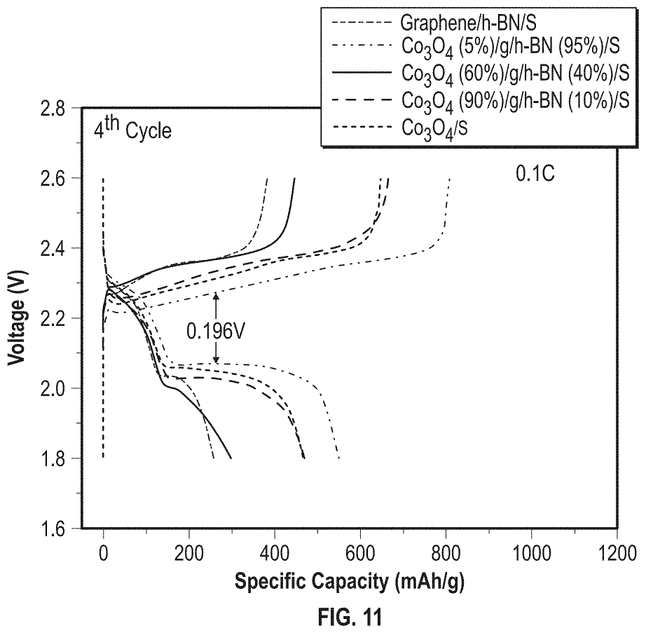

FIG. 11 shows electrochemical data of the samples in FIG. 8. FIG. 11 shows galvanostatic charge-discharge curves of the 4^{th} cycle at a current rate of 0.1 C where 1 C=1675 mAh/g. Unless otherwise indicated, 1 C=1675 mAh/g for all electrochemical data. As explained above, the samples were cycled from 1.8-2.6 V. Two voltage plateaus at 2.3 V and 2.0 V, which correspond to the typical discharge curve of Li—S batteries, can be observed for all samples.

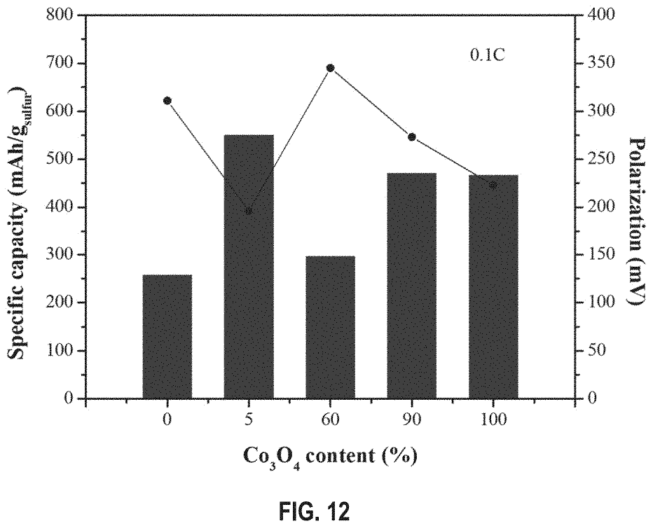

FIG. 12 is a plot of the specific capacity and the polarization (AE) between the charge and the discharge profiles from FIG. 11. Co₃O₄/graphene/h-BN/S with 5 wt. % Co₃O₄ in the Co₃O₄/graphene/h-BN nanocomposite displayed the highest charge/discharge capacity (806.76/550.38 mAh/g). This is indicative of enhanced sulfur utilization, which may be due to the strong interaction between Co₃O₄/graphene/h-BN/S and LiPSs. This may indicate that even a minimum amount of Co₃O₄ on the graphene/h-BN surface can effectively trap sulfur species, which reduces sulphur loss in the electrolyte. Sulphur species may be trapped chemically (e.g., electrostatic interactions between cobalt oxide species and sulphur species) or physically (e.g., sulphur species can be physically confined in the graphene and/or h-BN structures). Furthermore, the polarization between the charge and the discharge profiles was the lowest for the sample having 5 wt. % Co₃O₄ in the Co₃O₄/graphene/h-BN composite. This may be indicative of a more kinetically efficient reaction upon cycling of the Li—S battery. Co₃O₄/graphene/h-BN/S with 60 wt. % Co₃O₄ in the Co₃O₄/graphene/h-BN composite showed the highest polarization in charge/discharge profiles which may indicate that the redox kinetics of active sulfur and diffusion of soluble LiPS are slow. This could be due to the presence of less of the catalytically active phase of CoO. On the other hand, it's noteworthy that a decrease in coulombic efficiency may be due to insufficient LiNO₃ additive in the electrolyte that could act to form an effective passivation layer for the negative electrode.

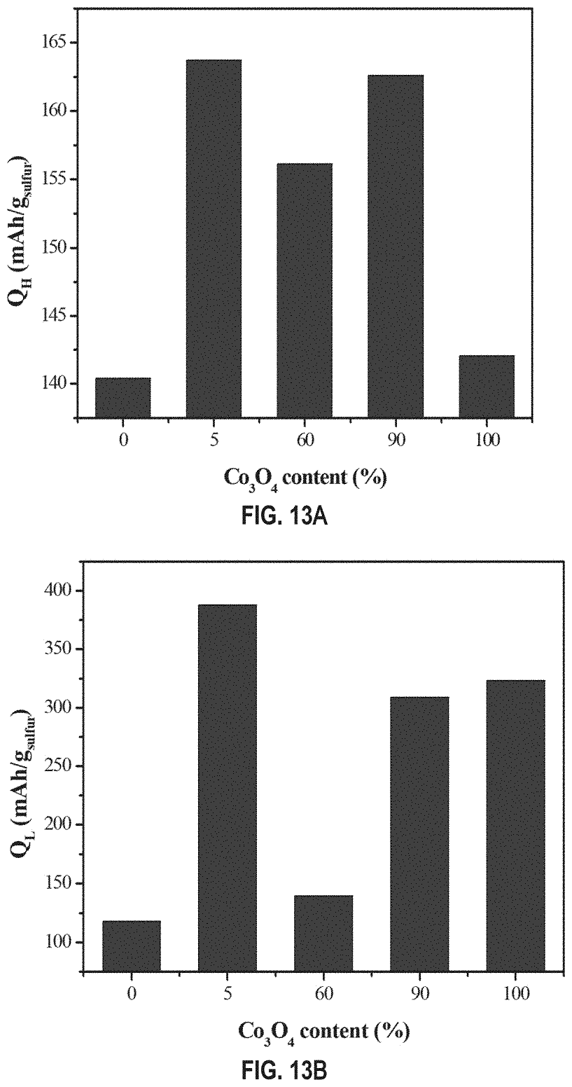

FIG. 13A a is a plot of the Q_{H} (the upper plateau discharge capacity) values from FIG. 11 and FIG. 13B is a plot of the Q_{L} (the lower plateau discharge capacity) values from FIG. 11. The Q_{H} is related to the fast solid to liquid transformation from sulfur to long soluble polysulfide species (or high-order polysulfide conversion from 2.6 to 2.3 V). This is used to determine the cathode performance based on polysulfide diffusion statuses such as formation, dissolution, and migration. As shown in Error! Reference source not found. A, the highest Q_{H} values and thus highest utilization at 0.1 C was observed for Co₃O₄/graphene/h-BN/S nanocomposites with 5 wt. %, 60 wt. % and 90 wt. % Co₃O₄ in the Co₃O₄/graphene/h-BN nanocomposites, respectively (163.7, 156.12, and 162.61 mAh/g). In contrast, graphene/h-BN/S (i.e., no Co₃O₄) and Co₃O₄/S (i.e., no graphene/h-BN) displayed a lower Q_{H} values of 140.39 and 142.04 mAh/g, respectively. Such high Q_{H} utilization for Co₃O₄/graphene/h-BN may indicate a synergistic effect of graphene/h-BN and Co₃O₄ in inhibiting and minimizing the diffusion of long-chain polysulfides due to the superior polysulfide adsorption capability.

Regarding FIG. 13B, Q_{L} values correspond to the slow liquid to solid conversion from soluble long-chain polysulfides to insoluble species (or low-order polysulfide conversion from 2.1 to 1.9 V) and are used to demonstrate the redox conversion capabilities of the cathode. Q_{L} also determines the capability of the cathode to eliminate the redeposition of the insulating Li₂S₂/Li₂S layer on the cathode surface and to inhibit the formation of agglomerated active material build-up on the composites. A high Q_{L} was observed for the sample having 5 wt. % Co₃O₄ in the Co₃O₄/graphene/h-BN composite (387.57 mAh/g at 0.1 C). This is three times higher than the graphene/h-BN/S sample (117.88 mAh/g). The high Q_{L} indicates the adequate reduction of the polysulfides to the end-discharge products which may be due to the interactions between polysulfides and surface species on the Co₃O₄, which is believed to contribute to its catalytic behavior. By increasing the Co₃O₄ content to 60 wt. %, a decrease in the Q_{L} value to 139.26 mAh/g was observed. This may be due to the absence of the catalytically active phase of CoO in this composite as shown in the XRD results in FIG. 1. Moreover, samples with a Co₃O₄ content of 90 and 100 wt. %, demonstrated high Q_{L} of 308.85 and 323.59 mAh/g, respectively. This may indicate that Co₃O₄ contributes to the facilitated adsorption and catalytic conversion of the polar intermediate LiPS. Sulfur utilization is calculated using the equation shown in formula (I):

Sulfur utilization (%)=((Specific capacity of Q_{L}/Specific Capacity of Q_{H})/3)*100 (I)

The sulfur utilization values for the samples in FIGS. 13a and 13b were 28%, 79%, 30%, 63%, and 76% for samples having 0%, 5%, 60%, 90% and 100% of Co₃O₄, respectively.

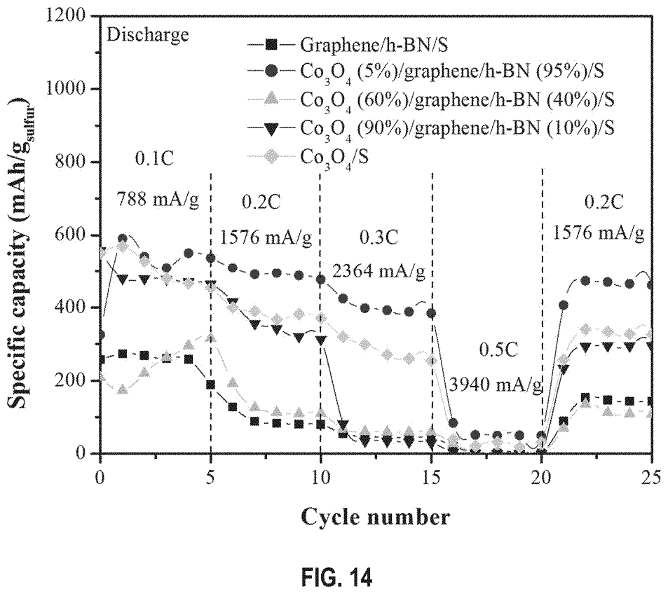

FIG. 14 shows the specific capacity upon cycling at different rates for the samples in FIG. 8. Rate performance was measured for five cycles at 0.1 C, 0.2 C, 0.3 C, 0.5 C and then 0.2 C cycling rates. The highest rate performance was observed for samples having 5 wt. % Co₃O₄ in the Co₃O₄/graphene/h-BN nanocomposite. This sample demonstrated the best rate performance at all cycling rates. As shown in cycles 20-25 at 0.2 C, this sample also was able to recover most of its capacity (95-98%) after being cycled at a high rate, while the rest of the samples did not recover their capacity. The good cycling performance, even at high cycling rates, may be due to an enhanced electrocatalytic effect and good anchoring sites. An anchoring site is a location on the graphene/h-BN where Co₃O₄ species bind to the graphene/h-BN structure. Good anchoring sites help prevent agglomeration of cobalt oxide species, which may reduce its catalytic effects.

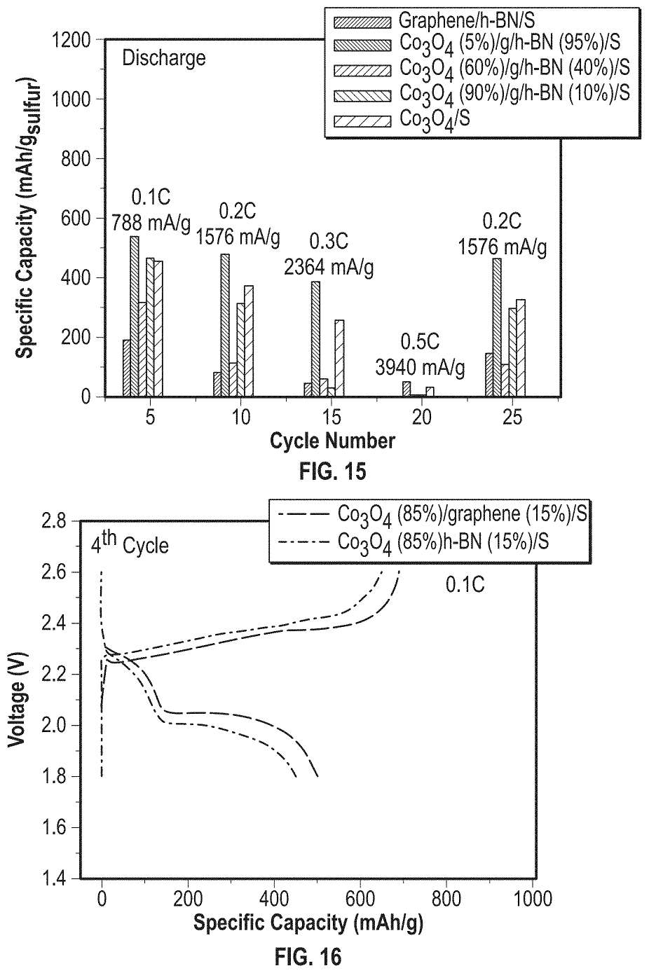

FIG. 15 is a chart comparing the data of FIG. 14.

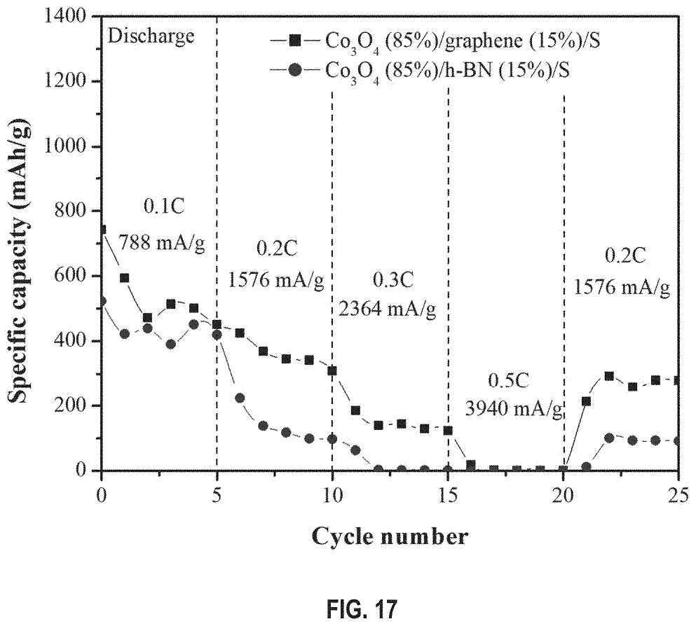

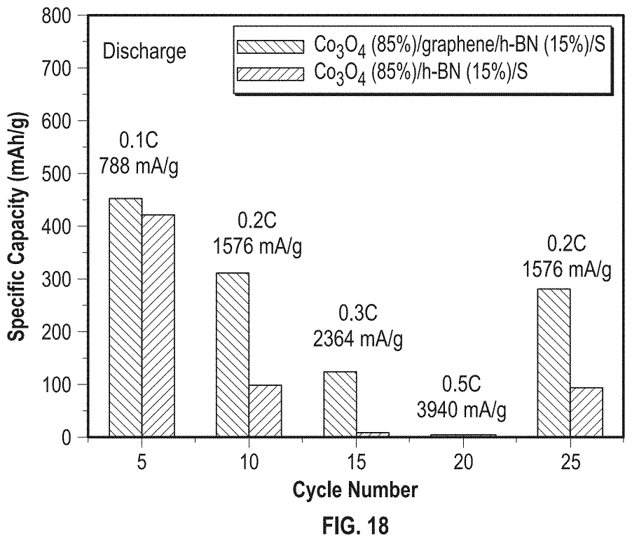

FIGS. 16-18 show the electrochemical performance of composites having Co₃O₄, sulphur and either graphene or h-BN, not both. Specifically, FIG. 16 shows galvanostatic charge-discharge curves of the 4^{th} cycle at a current rate of 0.1 C, FIG. 17 shows the rate performance of these samples, and FIG. 18 is a plot comparing the data in FIG. 17. The samples having graphene generally had better electrochemical properties than the samples having h-BN.

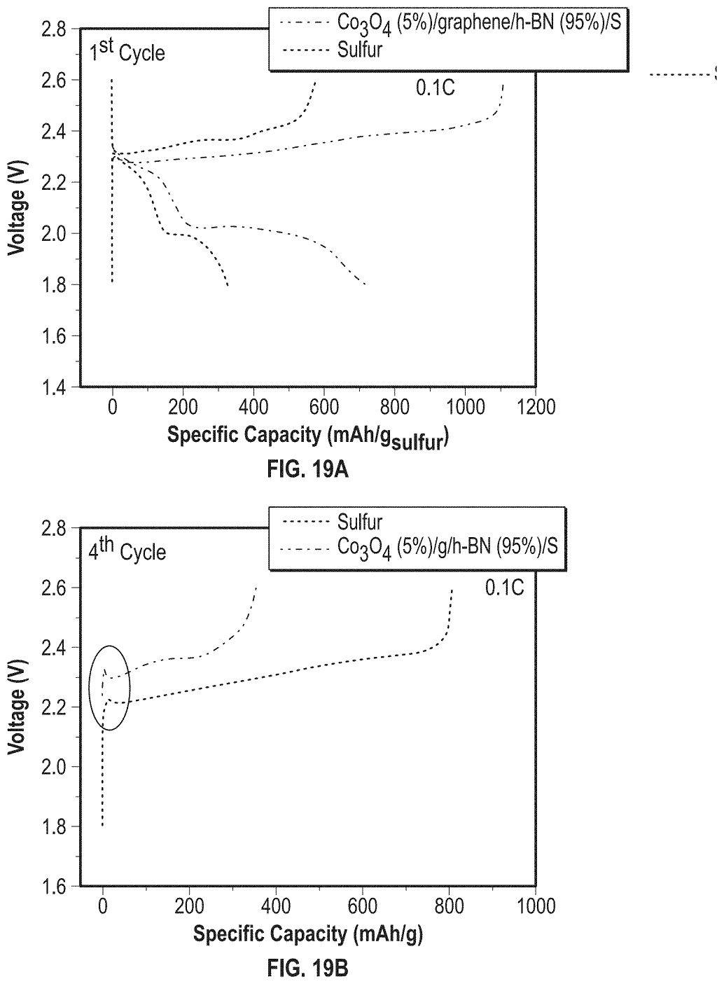

FIGS. 19-21 show the electrochemical performance of samples having 5 wt. % Co₃O₄ in the Co₃O₄/graphene/h-BN nanocomposite as compared to elemental sulfur. The electrode with elemental sulfur had a sulfur loading of 2.345 mg/cm². Specifically, FIG. 19A shows galvanostatic charge-discharge curves of the first cycle at a current rate of 0.1 C and FIG. 19B shows the galvanostatic charge curves of the fourth cycle at a current rate of 0.1 C. FIG. 19A shows a lower potential difference between the charge and discharge profiles for the sample having Co₃O₄. This is indicative of a kinetically efficient reaction process and a smaller energy barrier promoted by Co₃O₄/graphene/h-BN/S catalyzing process. FIG. 19B shows that the addition of the nanocomposite reduces the height of the potential barrier to 2.23 V on the charge as compared to the 2.33V for elemental sulfur (circled in the plot to show the potential barrier difference). The lower potential barrier of the Co₃O₄/graphene/h-BN/S cathode may indicate improved conductivity and reduced charge transfer resistance also suggesting the high catalytic activity of the Co₃O₄/graphene/h-BN/S. The sample having 5 wt. % Co₃O₄ in the Co₃O₄/graphene/h-BN nanocomposite had higher specific charge-discharge capacities of 1107.87/776.54 mAh/g. Sulfur had a lower charge/discharge capacity of 573.12/449.81 mAh/g. This corresponds to a high sulfur utilization of 83 wt. % for sample having 5 wt. % Co₃O₄ in the Co₃O₄/graphene/h-BN nanocomposite and a low sulfur utilization of only 34 wt. % for elemental sulfur.

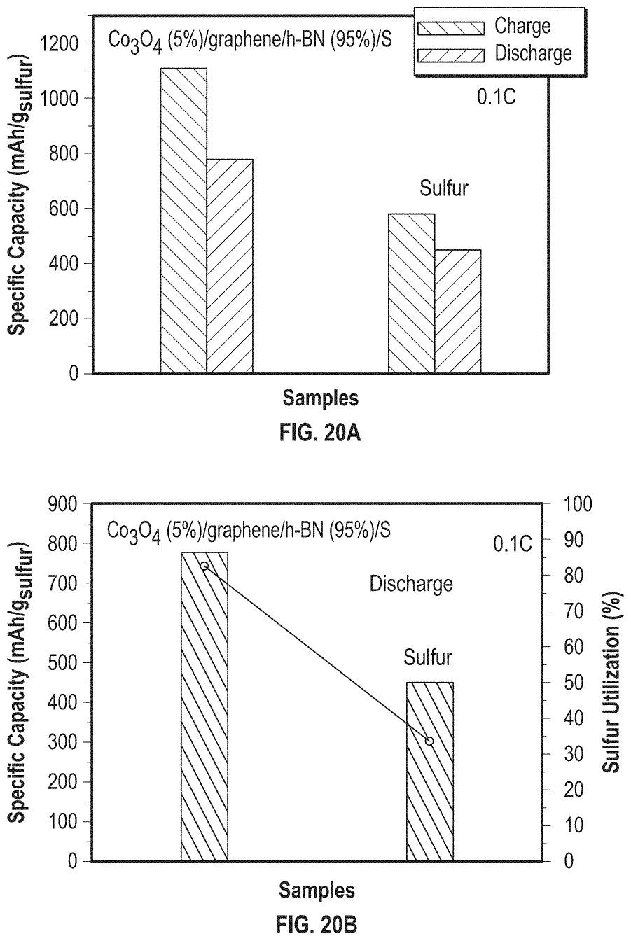

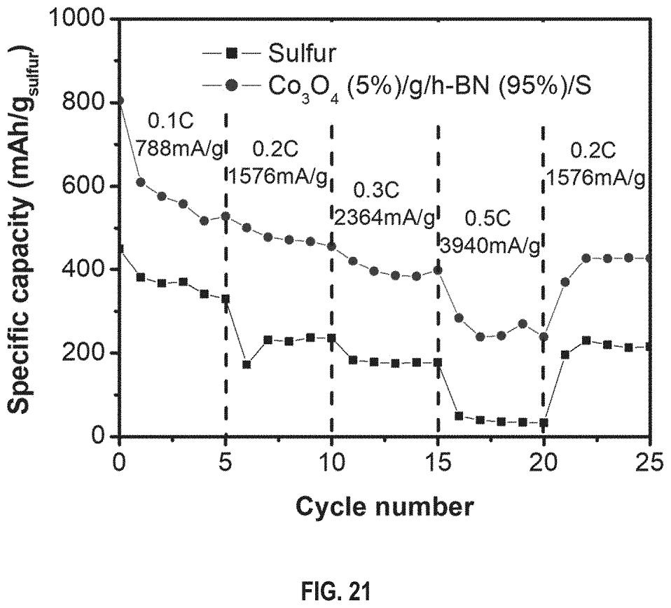

FIG. 20A is a plot comparing the specific charge-discharge capacities from the data in FIG. 19A. FIG. 21 is a plot comparing the specific capacities on discharge and sulfur utilization from the data in FIG. 19A.

FIG. 21 shows the specific capacity upon cycling at different rates of samples having 5 wt. % Co₃O₄ in the Co₃O₄/graphene/h-BN nanocomposite as compared to elemental sulfur. Rate performance was measured for five cycles at 0.1 C, 0.2 C, 0.3 C, 0.5 C and then 0.2 C cycling rates. As shown, higher specific capacities were achieved for the samples having Co₃O₄ at all rates.

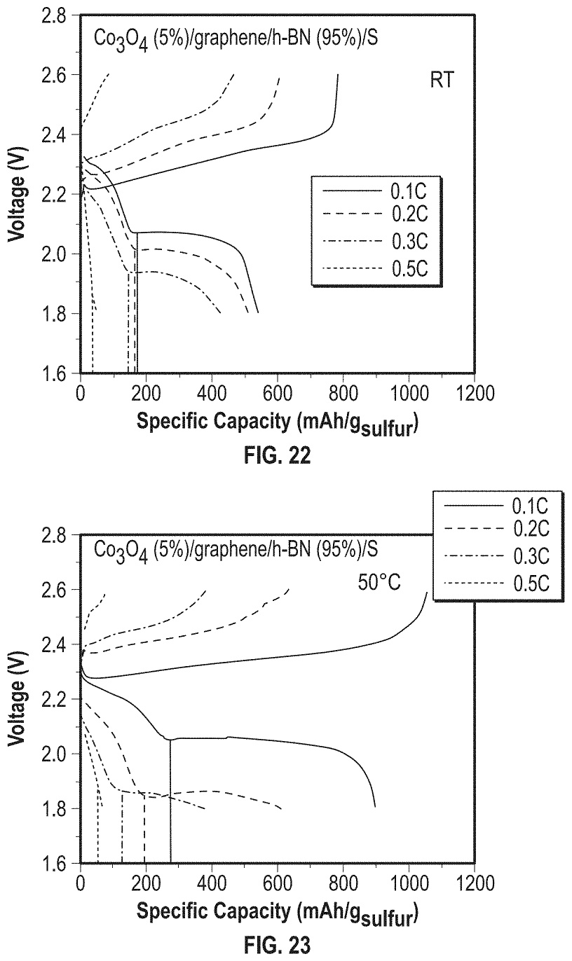

FIG. 22 shows galvanostatic charge-discharge curves of the 5^{th} cycle at 0.1 C, the 6^{th} cycle at 0.2 C, the 11^{th} cycle at 0.3 C and the 25^{th} cycle at 0.5 C at room temperature for samples having 5 wt. % Co₃O₄ in the Co₃O₄/graphene/h-BN nanocomposite.

FIG. 23 shows galvanostatic charge-discharge curves of the 5^{th} cycle at 0.1 C, the 6^{th} cycle at 0.2 C, the 11^{th} cycle at 0.3 C and the 25^{th} cycle at 0.5 C at 50° C. for samples having 5 wt. % Co₃O₄ in the Co₃O₄/graphene/h-BN nanocomposite.

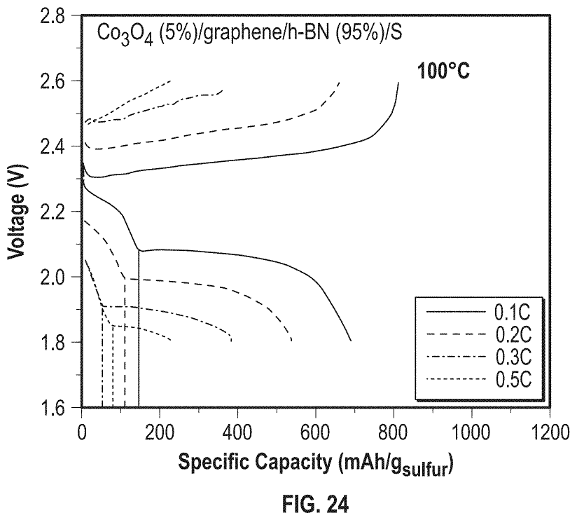

FIG. 24 shows galvanostatic charge-discharge curves of 5^{th} cycle at 0.1 C, the 6^{th} cycle at 0.2 C, the 11^{th} cycle at 0.3 C and the 25^{th} cycle at 0.5 C at 100° C. for samples having 5 wt. % Co₃O₄ in the Co₃O₄/graphene/h-BN nanocomposite.

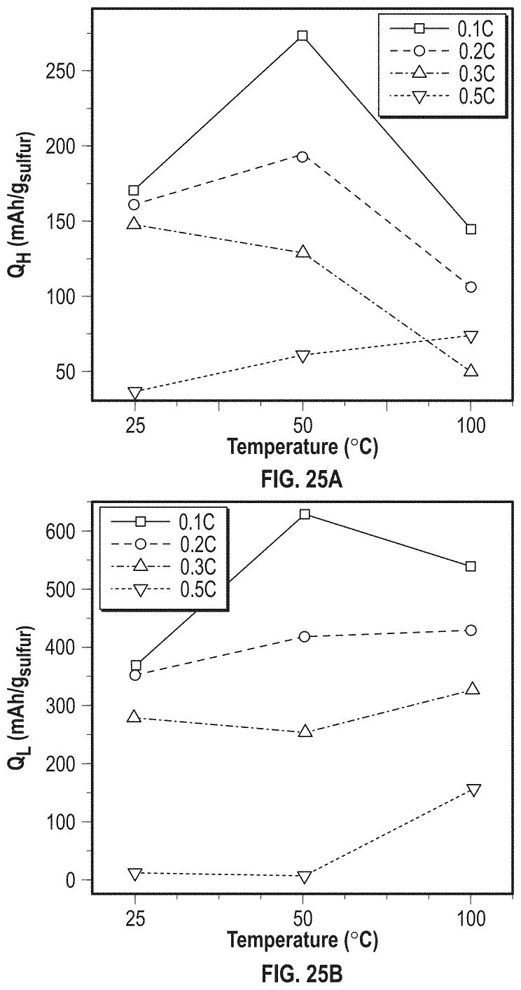

FIG. 25A is a plot of the Q_{H} values obtained from FIGS. 22-24.

FIG. 25B is a plot of the Q_{L} values obtained from FIGS. 22-24.

As shown in FIG. 25A, at current rates of 0.1 C and 0.2 C, heating the cell to 50° C. increased the Q_{H} value when compared to the electrochemical performances at room temperature. Without being bound by any particular mechanism or theory, it is believed that increasing the temperature may contribute to the suppression of long polysulfide diffusion. However, when the temperature was increased to 100° C., the Q_{H} value decreased. This may be due to the highly active PS shuttle process in the absence of any physical confinement of sulfur in the electrode at lower currents. When the current was increased to 0.3 C, a similar trend was observed but with a slightly lower Q_{H} value for the cell tested at 50° C. when compared to room temperature. At a higher current rate of 0.5 C, the Q_{H} value increased with increasing temperature. Therefore, increasing the temperature at high currents does not significantly alter the behavior, but may inhibit polysulfide diffusion.

As shown in FIG. 25B, the Q_{L} values at current rates of 0.1 C and 0.2 C were also higher at 50° C. This may indicate that a higher temperature enhances the redox conversion of the Li—S battery when compared to the cell operating at room temperature. The Q_{L} value slightly decreased at 100° C., but was higher than Q_{L} obtained at room temperature. This could be also due to the high activity of the polysulfide species at the lower currents and the lack of confinement of the sulfur on the electrode. As expected, at higher current rates of 0.3 C and 0.5 C, the highest Q_{L} value was achieved when the cell was operated at 100° C., and thus enhanced redox reaction conversion.

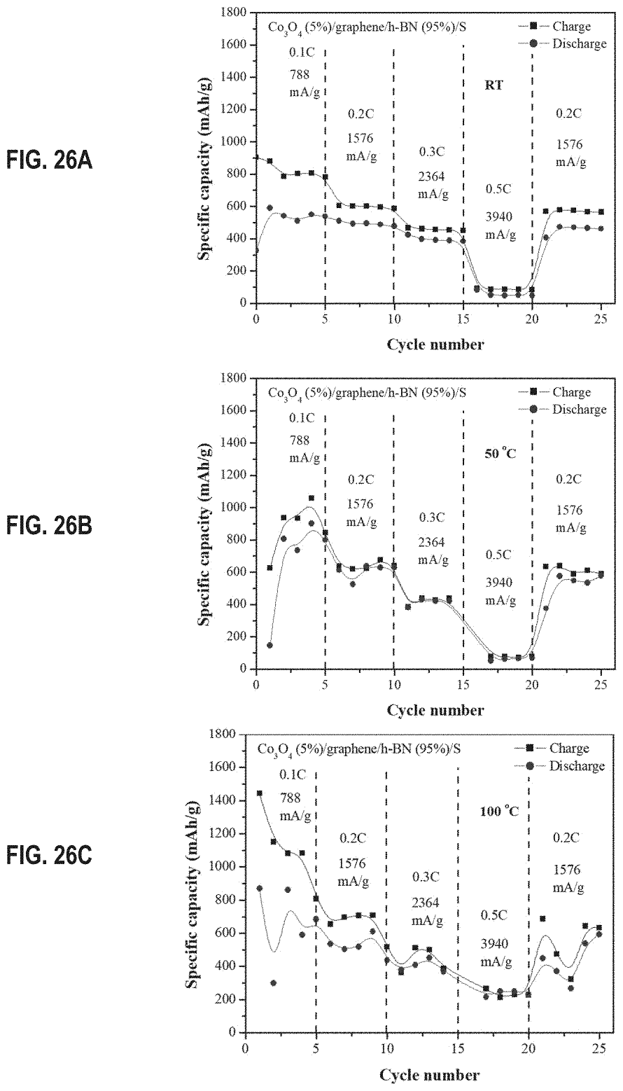

FIG. 26A is a plot of the rate performance for charge and discharge cycles at room temperature for samples having 5 wt. % Co₃O₄ in the Co₃O₄/graphene/h-BN nanocomposite. Rate performance was measured for five cycles at 0.1 C, 0.2 C, 0.3 C, 0.5 C and then 0.2 C cycling rates.

FIG. 26B is a plot of the rate performance for charge and discharge cycles at 50° C. for samples having 5 wt. % Co₃O₄ in the Co₃O₄/graphene/h-BN nanocomposite. Rate performance was measured for five cycles at 0.1 C, 0.2 C, 0.3 C, 0.5 C and then 0.2 C cycling rates.

FIG. 26C is a plot of the rate performance for charge and discharge cycles at 100° C. for samples having 5 wt. % Co₃O₄ in the Co₃O₄/graphene/h-BN nanocomposite. Rate performance was measured for five cycles at 0.1 C, 0.2 C, 0.3 C, 0.5 C and then 0.2 C cycling rates.

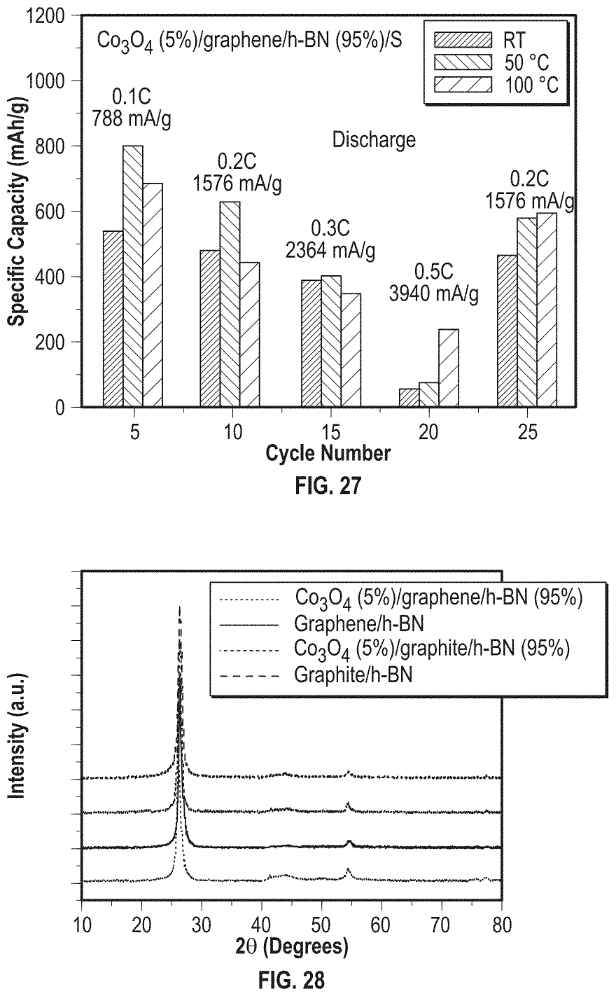

FIG. 27 is a plot comparing the rate performance data of FIGS. 26a-26c. Notably, the samples cycled at 50° C. showed better performance at lower current rates when compared to cells cycled at room temperature or 100° C.

FIG. 28 shows XRD patterns of samples made according to Examples 4, specifically comparing samples with graphene to samples with graphite. From bottom to top, the samples are a Co₃O₄/graphene/h-BN sample with 5 wt. % Co₃O₄, graphene/h-BN, Co₃O₄/graphite/h-BN sample with 5 wt. % Co₃O₄, and graphite/h-BN. The addition of 5 wt. % of Co₃O₄ to either graphene/h-BN or graphite/h-BN resulted in a slight downshift in the peak position of the (002) peak when compared to graphene/h-BN or graphite/h-BN. This may be indicative of an expansion in the interlayer distance of the (002) peak due to Co₃O₄ intercalation into the graphene/h-BN or graphite/h-BN matrix.

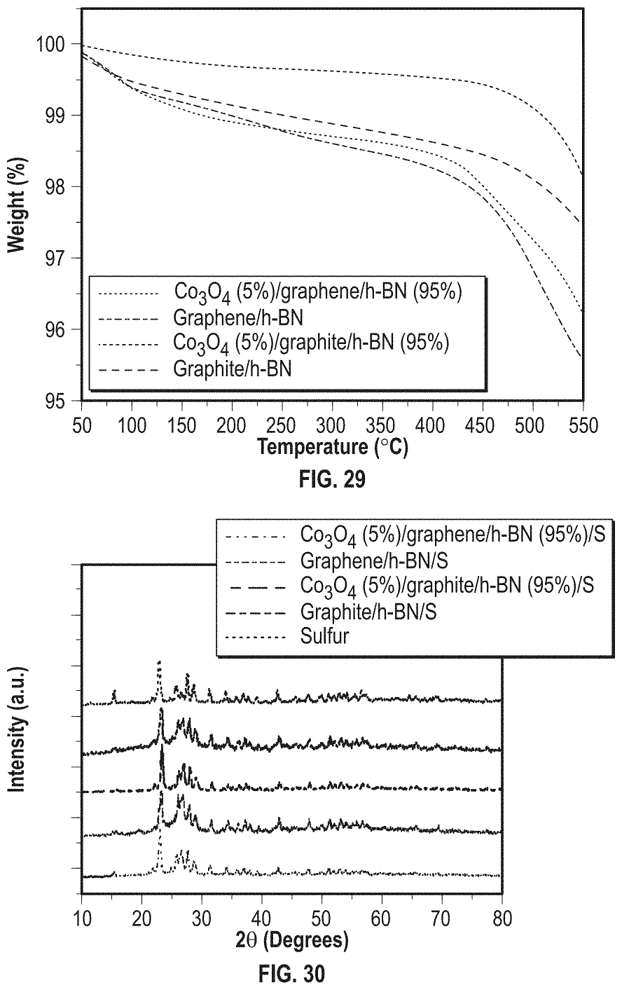

FIG. 29 shows TGA data for the samples in FIG. 28. Samples with graphite have slightly higher thermal stability than samples with graphene.

FIG. 30 shows XRD patterns of the samples in FIG. 28 after they have been ball milled with 70 wt. % sulfur. Elemental sulfur is also shown for comparison (top). FIG. 30 confirms the crystalline nature of the sulfur in all of the samples.

FIG. 31 shows TGA data for the samples in FIG. 30. FIG. 30 confirms the presence of 70 wt. % sulfur in the samples. The samples having graphene appear to have a stronger interaction with sulfur when compared to the samples having graphite, as the graphene samples had higher evaporation temperatures for the sulfur.

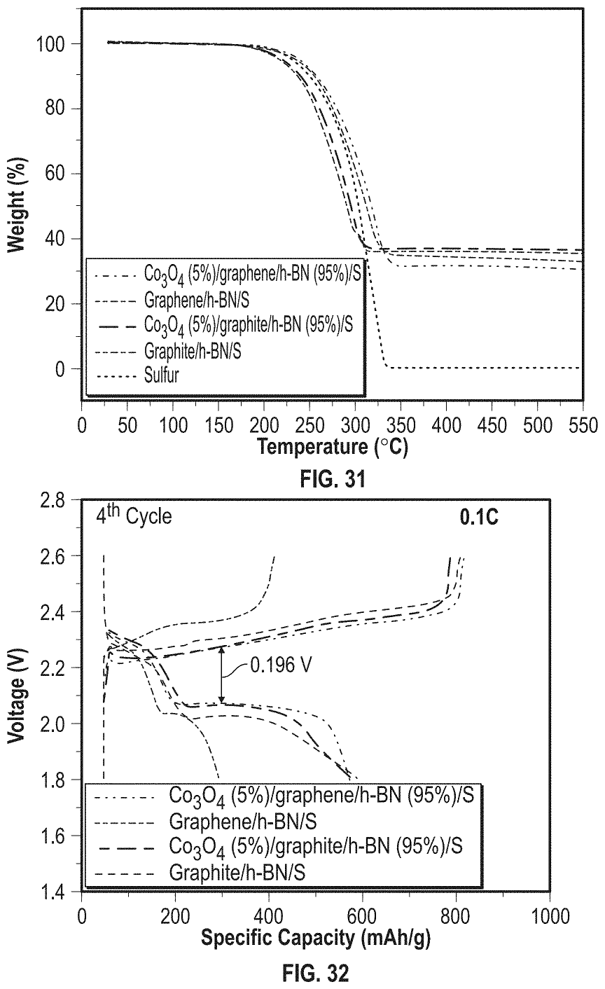

FIG. 32 shows galvanostatic charge-discharge curves of the 4^{th} cycle at a current rate of 0.1 C for the samples described in FIG. 30. Co₃O₄/graphene/h-BN/S, graphene/h-BN/S, Co₃O₄/graphite/h-BN/S, and graphite/h-BN/S had specific discharge capacities of 550.38, 258.08, 556.55, and 568.45 mAh/g, respectively. A lower polarization was achieved for samples having Co₃O₄, indicating fast charge transfer kinetics and effective utilization of active sulfur species. There were no significant differences observed between the samples containing graphene and graphite. This may indicate that during cycling, graphite sheets may undergo exfoliation resulting in a structure similar to graphene.

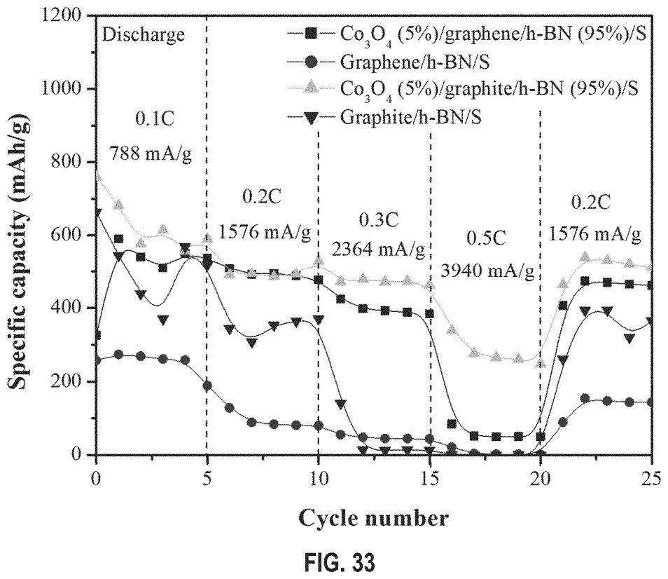

FIG. 33 is a plot of the rate performance for charge and discharge cycles for the samples described in FIG. 30 (i.e., graphene vs. graphite samples). Rate performance was measured for five cycles at 0.1 C, 0.2 C, 0.3 C, 0.5 C and then 0.2 C cycling rates.

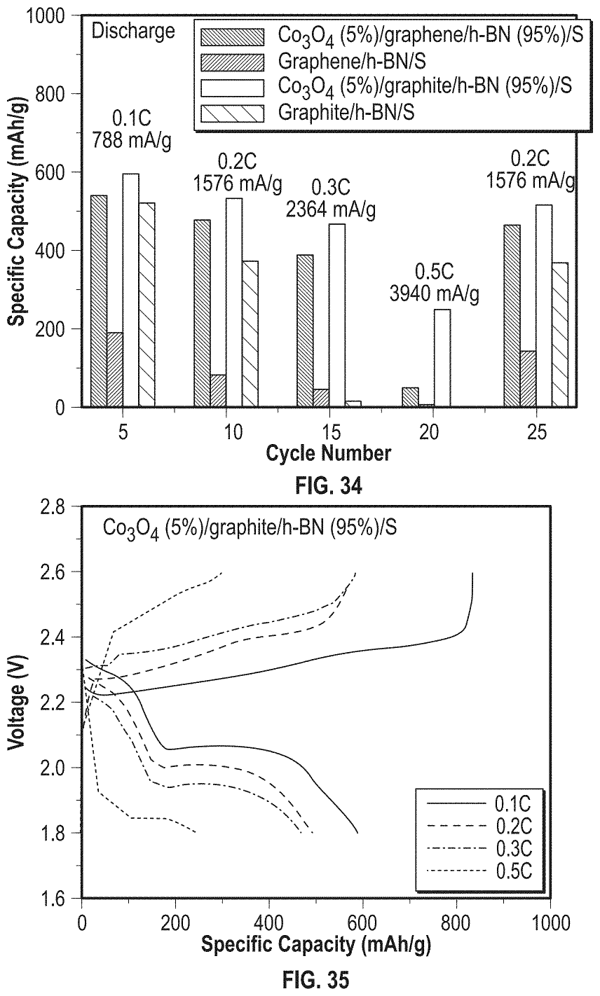

FIG. 34 is a plot comparing the data shown in FIG. 33. The sample of Co₃O₄/graphite/h-BN sample with 5 wt. % Co₃O₄ had the best performance at all rates.

FIG. 35 shows galvanostatic charge-discharge curves of 5^{th} cycle at 0.1 C, the 6^{th} cycle at 0.2 C, the 11^{th} cycle at 0.3 C and the 25^{th} cycle at 0.5 C at room temperature for samples having 5 wt. % Co₃O₄ in the Co₃O₄/graphite/h-BN nanocomposite. Generally, as current rate increased, the capacity decreased and the polarization increased. Although the polarization increased with the increase in the current rate, the typical charge-discharge curve of Li—S batteries was maintained which may indicate good stability of Co₃O₄/graphite/h-BN nanocomposite under high currents.

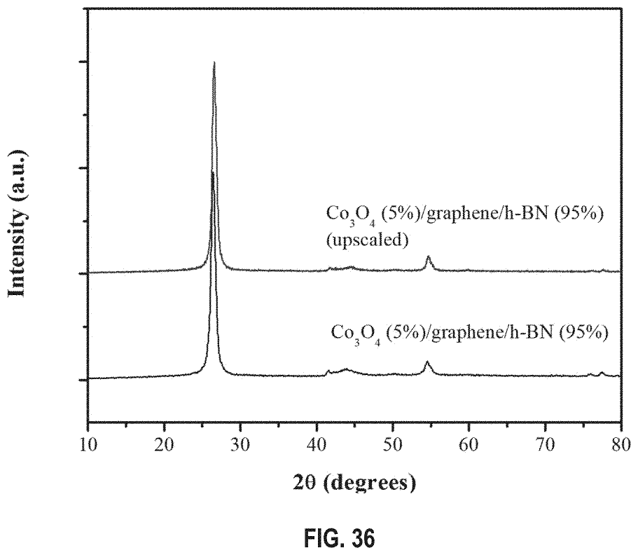

FIG. 36 shows XRD patterns of two samples of Co₃O₄/graphene/h-BN sample with 5 wt. % Co₃O₄. The bottom pattern is a sample made according to Example 1, the top pattern is a sample made using low-energy ball milling according to Example 11. The sample prepared via low energy ball milling showed a slight downshift in the peak position of the (002) plane. This may be indicative of an expansion in the interlayer distance of the (002) which might indicate more Co₃O₄ intercalation.

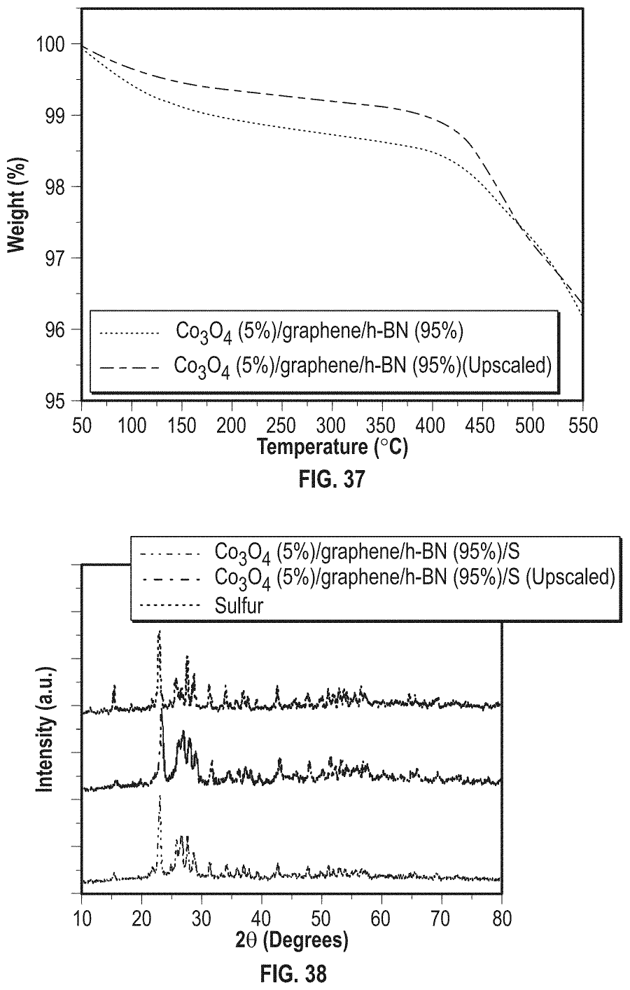

FIG. 37 shows TGA data for the samples in FIG. 36. Both samples have similar weight loss of about 4 wt. % at 550° C., indicating the samples are thermally stable up to 550° C.

FIG. 38 shows XRD patterns of the samples in FIG. 36 after they have been ball milled with 70 wt. % sulfur. Elemental sulfur is also shown for comparison (top). The elemental sulfur exhibits several narrow crystalline peaks, with three prominent peaks at 23.1°, 25.9°, and 27.8° which can be indexed as the (222), (026) and (311) planes of the fddd orthorhombic structure of sulfur. Similarly, the characteristic peaks of sulfur in these samples are still crystalline and did not exhibit any changes, indicating that no phase transformation of the sulfur occurred during ball-milling.

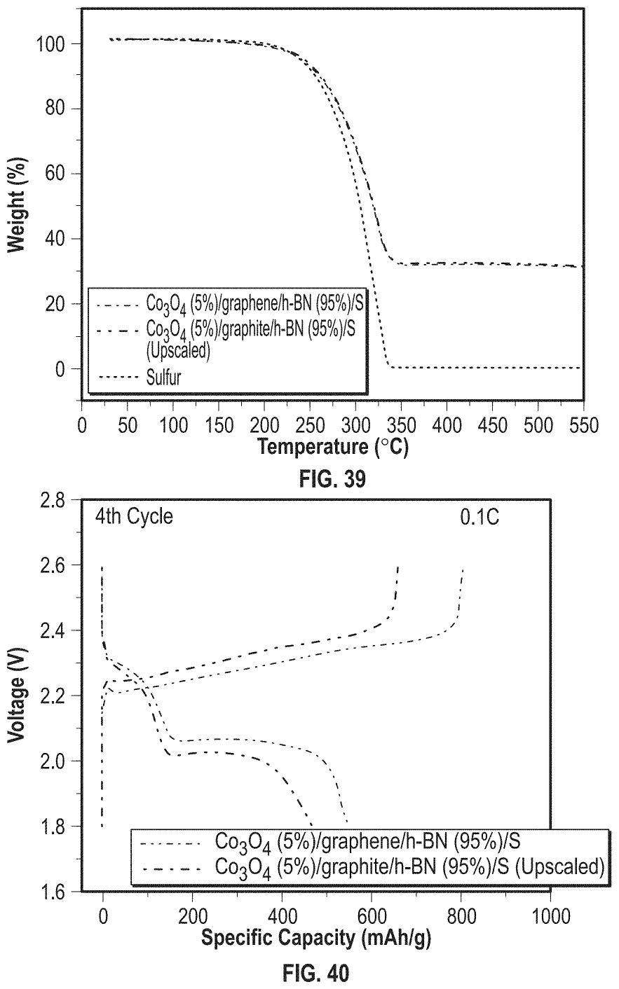

FIG. 39 shows TGA data for the samples in FIG. 38. From TGA, the sulfur content in these samples was determined to be 70 wt. %. One major weight loss that occurs between 200 to 400° C. corresponds to the sublimation of sulfur. The complete evaporation of sulfur in the composite occurred at −345° C., which was higher when compared to the evaporation of pure sulfur. The higher evaporation temperature suggests a binding interaction between sulfur and the composite and the need for extra energy to remove sulfur.

FIG. 40 shows galvanostatic charge-discharge curves of the 4^{th} cycle at a current rate of 0.1 C for the samples described in FIG. 38. The electrochemical performance of the sample made via low-energy ball milling had lower electrochemical performance. Specifically, samples made by low energy ball milling had lower specific capacities and higher polarization.

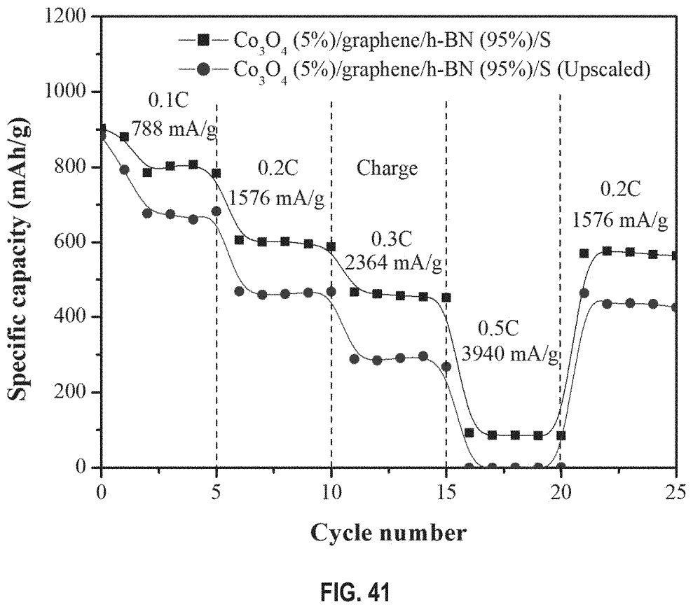

FIG. 41 is a plot of the rate performance for charge and discharge cycles for the samples described in FIG. 38 (i.e., graphene vs. graphite samples). Rate performance was measured for five cycles at 0.1 C, 0.2 C, 0.3 C, 0.5 C and then 0.2 C cycling rates.

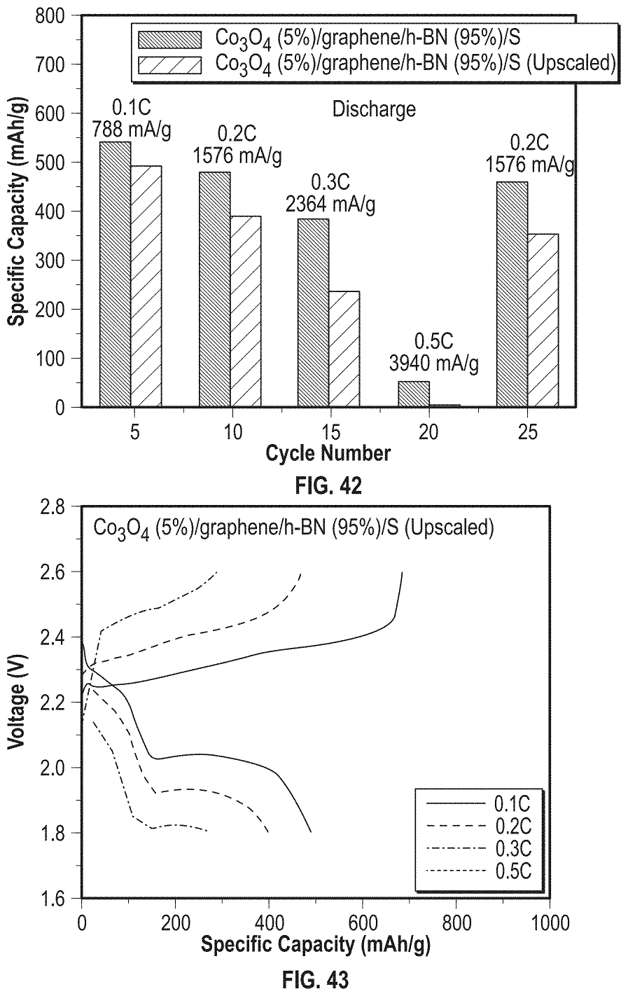

FIG. 42 is a plot comparing the data shown in FIG. 41. The sample made via low energy ball milling had lower capacity than the sample made via high energy ball milling. The samples all showed reversible capacity.

FIG. 43 shows galvanostatic charge-discharge curves of 5^{th} cycle at 0.1 C, the 6th cycle at 0.2 C, the 11^{th} cycle at 0.3 C and the 25^{th} cycle at 0.5 C at room temperature for the sample made via low energy ball milling. The capacity decreases with increasing rate due to increased polarization.

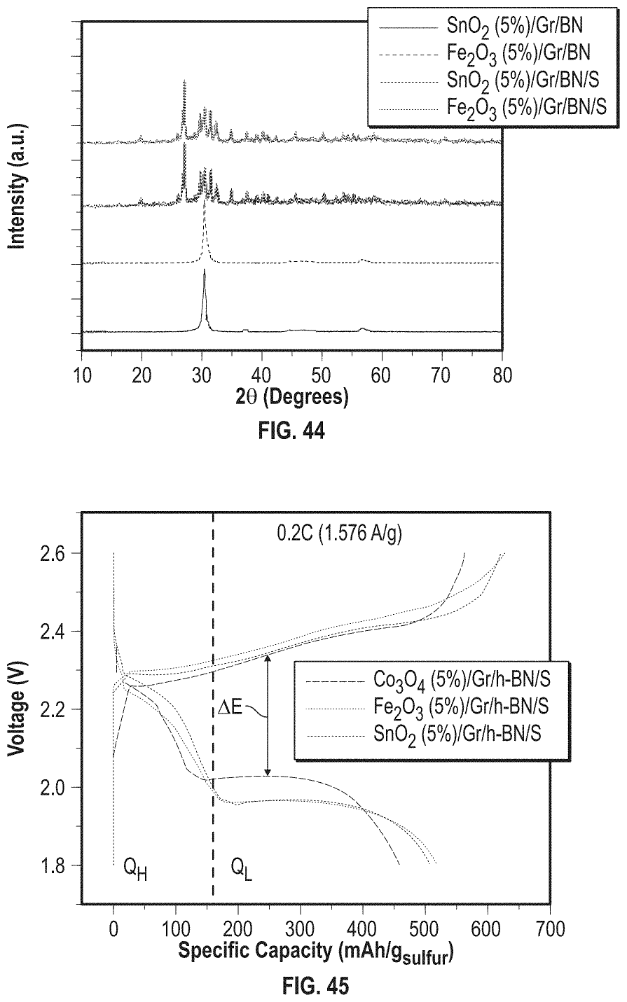

FIG. 44 shows an XRD pattern of samples made according to Example 5. Specifically a sample of SnO₂/graphene/h-BN with 5 wt. % SnO₂ and a sample of Fe₂O₃/graphene/h-BN with 5 wt. % Fe₂O₃ are plotted in addition to these two samples having been ball milled with 70 wt. % sulfur according to Example 8. The samples without sulfur show no XRD peaks indicative of SnO₂ or Fe₂O₃. This may be due to the low content of the metal oxides, the low relative crystallinity of the metal oxides as compared to the graphene/h-BN, or the diffusion of SnO₂ or Fe₂O₃ into the graphene/h-BN structures.

FIG. 45 shows galvanostatic charge-discharge curves of the 10^{th} cycle at different current rates at room temperature for the sulfur-containing samples described in FIG. 44 and for the Co₃O₄/graphene/h-BN/S with 5 wt. % Co₃O₄ in the Co₃O₄/graphene/h-BN nanocomposite. As shown, samples with tin and iron oxides show similar electrochemical performance to the cobalt oxide samples. Co₃O₄ resulted in a lower polarization which could be attributed to the higher catalytic activity of Co₃O₄/graphene/h-BN/S nanocomposite.

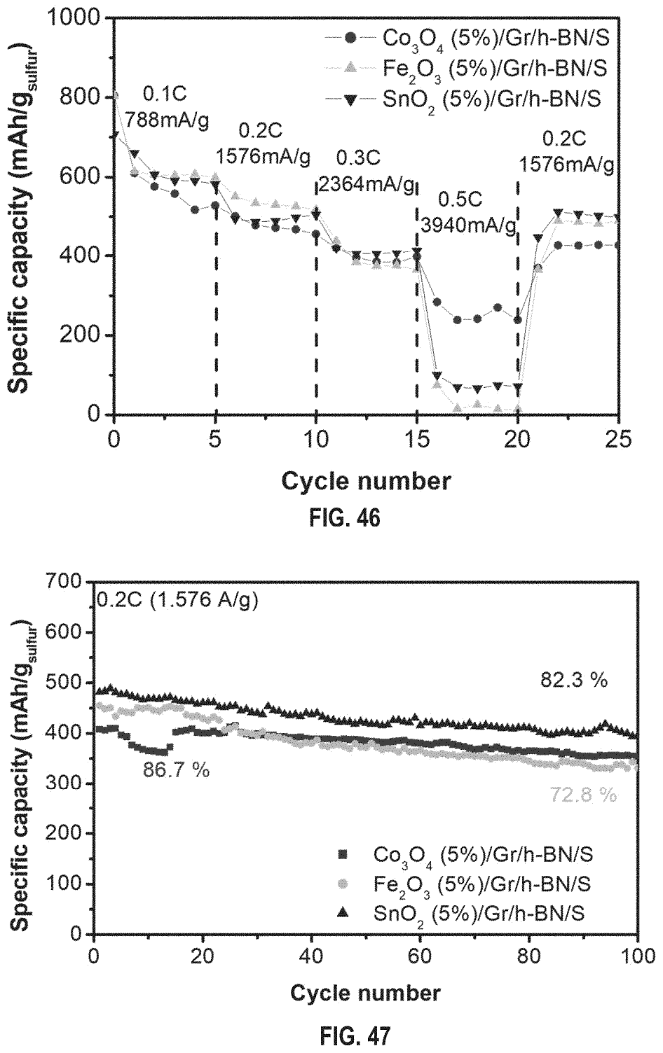

FIG. 46 is a plot of the rate performance for charge and discharge cycles for the samples described in FIG. 45. Rate performance was measured for five cycles at 0.1 C, 0.2 C, 0.3 C, 0.5 C and then 0.2 C cycling rates. A higher capacity was obtained for Co₃O₄/graphene/h-BN/S nanocomposite at a high current density of 3940 mA/g.

FIG. 47 is a plot of capacity retention for samples described in FIG. 45. The cycling rate was 0.2 C. After 100 cycles, the highest capacity retention was for Co₃O₄ samples with a capacity retention of 86.7%, further indicating the minimal loss of sulfur species during cycling. Capacity retention values of 82.3% and 72.8% were achieved for SnO₂ and Fe₂O₃ samples, respectively.

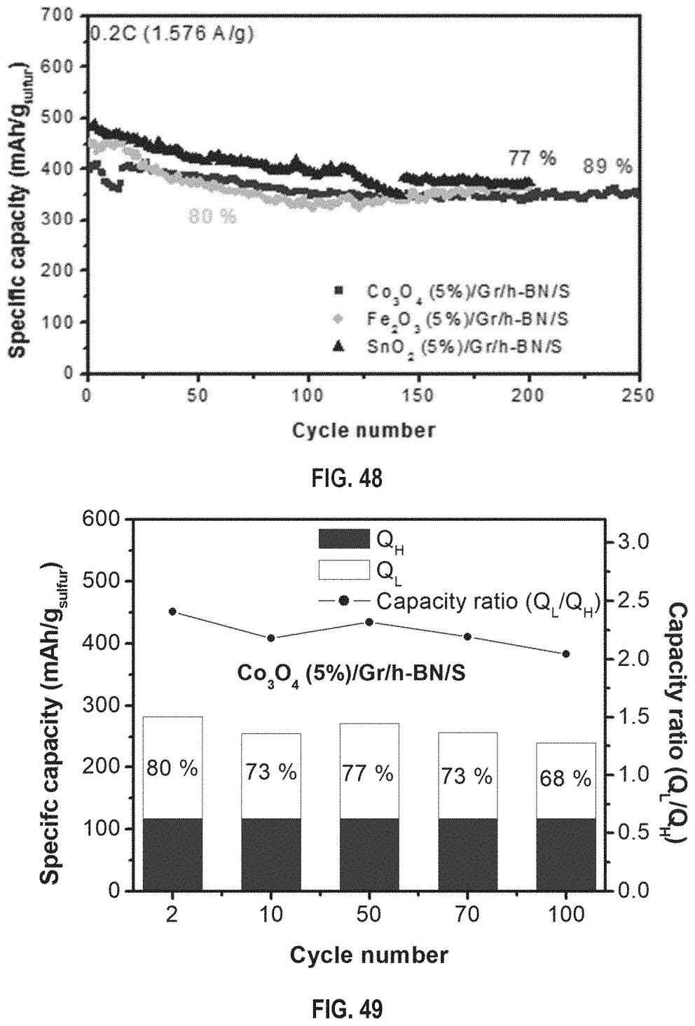

FIG. 48 is a plot of capacity retention for samples described in FIG. 45. The cycling rate was 0.2 C. The capacity retention for the sample with Co₃O₄ was 89% after 200 cycles. The capacity retention for the sample with SnO₂ was 77% after 200 cycles. The capacity retention for the sample with Fe₂O₃ was 80% after 200 cycles. Such increases in capacity as the cycle number increases may be due to an increase in surface area of the electrode as it is cycled.

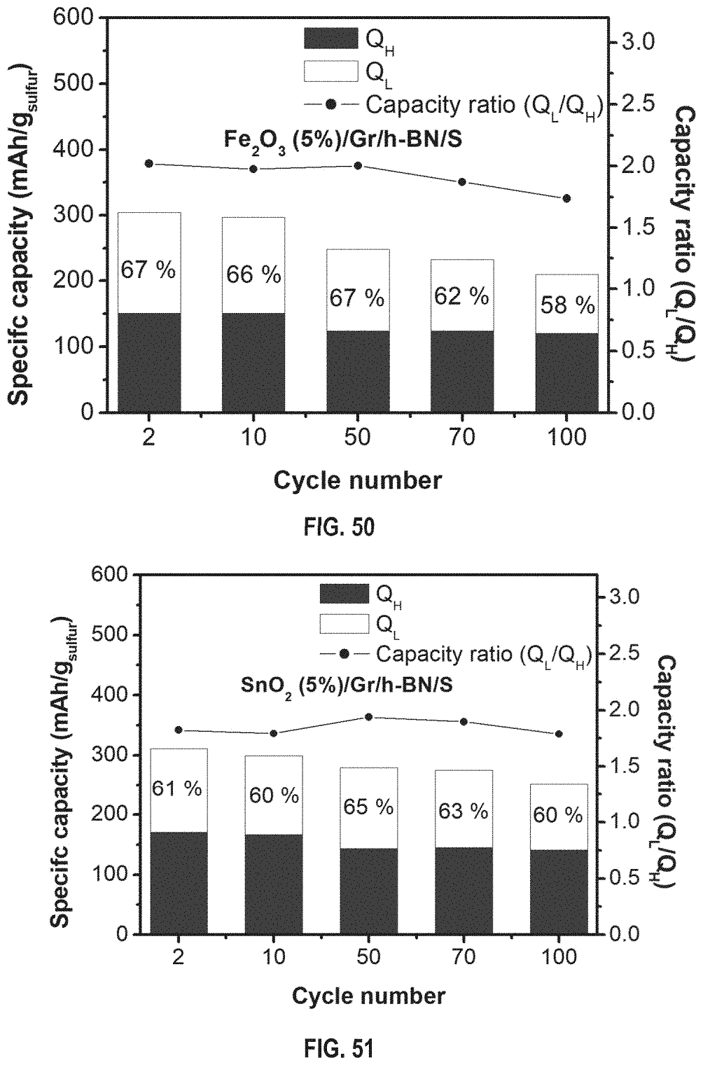

In electrochemical cycling (charge-discharge) Q_{H} (the upper voltage plateau) is indicative of when S₈ is converted to Li₂S₆ and Li₂S₄. During Q_{L} (the lower voltage plateau), Li₂S₄ is converted to Li₂S₂ and Li₂S. The ratio of Q_{H}/Q_{L} can determine the type of sulfur species lost during cycling. A full conversion of higher-order polysulfides to insoluble polysulfides (Li₂S) gives Q_{L}/Q_{H} ratio of 3 while conversion to Li₂S₂ results in Q_{L}/Q_{H}=2. Q_{L}/Q_{H} values were calculated for the samples described in FIG. 47 at different cycle numbers, and are shown in FIGS. 49-51. The data from the sample having Co₃O₄ is shown in FIG. 49, the data from the sample having Fe₂O₃ is shown in FIG. 50 and the data from the sample having SnO₂ is shown in FIG. 51. As shown, the sample having Co₃O₄ has the highest capacity ratio at 100 cycles.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. An electrode material comprising:
a nanocomposite comprising:
from 0.1 to 15 wt. % of a metal oxide;
carbon; and
h-BN; and
sulfur.

2. The electrode material of claim 1, wherein the metal oxide is selected from the group consisting of Co₃O₄, Fe₂O₃, SnO₂, and combinations thereof.

3. The electrode material of claim 2, wherein the metal oxide is selected from the group consisting of Fe₂O₃, SnO₂, and combinations thereof.

4. The electrode material of claim 1, comprising from 2 to 7 wt. % of the metal oxide.

5. The electrode material of claim 1, comprising about 5 wt. % of the metal oxide.

6. The electrode material of claim 1, wherein the carbon is selected from the group consisting of graphene, graphite and combinations thereof.

7. The electrode material of claim 6, wherein the carbon is graphite. The electrode material of claim 1, wherein the metal oxide comprises CoO.

8. The electrode material of claim 1, comprising at least 60 wt. % sulfur.

9. The electrode material of claim 1, wherein a ratio of carbon to h-BN is from 1:9 to 9:1.

10. A lithium-sulfur battery comprising an anode, a cathode, a separator and an electrolyte, the cathode comprising:
a nanocomposite comprising:
from 0.1 to 15 wt. % of a metal oxide;
carbon; and
h-BN; and
sulfur.

11. The lithium-sulfur battery of claim 10, wherein the cathode comprises a sulfur loading of at least 2 mg/cm².

12. The lithium-sulfur battery of claim 10, comprising a sulfur utilization of at least 65% as calculated on the fourth cycle.

13. The lithium-sulfur battery of claim 10, comprising a sulfur utilization of at least 75% as calculated on the fourth cycle.

14. The lithium-sulfur battery of claim 10, wherein after 100 cycles at a cycling rate of 0.2 C, at least 70% of capacity is retained.

15. The lithium-sulfur battery of claim 10, wherein after 200 cycles at a cycling rate of 0.2 C, at least 75% of capacity is retained.

16. The lithium-sulfur battery of claim 10, comprising a specific capacity of at least 500 mAh/g on the 5^{th} cycle when cycled at 0.1 C at room temperature.

17. The lithium-sulfur battery of claim 10, wherein the cathode comprises a thickness of from 50 to 300 μm.

18. A method of preparing an electrode comprising:
milling a metal precursor, carbon, and h-BN to make a precursor mixture;
heating the precursor mixture to a predetermined temperature in the presence of oxygen to form a nanocomposite, wherein the nanocomposite comprises from 0.1 to 15 wt. % of a metal oxide;
mixing the nanocomposite with sulfur to create an electrode mixture;
forming an electrode from the electrode mixture.

19. The method of claim 18, wherein the milling comprises high energy ball milling.

20. The method of claim 18, wherein the milling comprises low energy ball milling.

21. The method of claim 18, wherein the predetermined temperature is from 325 to 375° C.

22. The method of claim 18, further comprising blending the electrode mixture with one or more conductive agents, a binding agent, an optional additive, and a solvent to obtain a slurry.

23. The method of claim 22, further comprising applying the slurry onto a substrate to form a film.

24. The method of claim 23, further comprising drying the film.

25. The method of claim 24, wherein the film comprises a thickness of from 50 to 300 μm.
